(19) United States
(12) Patent Application Publication
(10) Pub. No.: US 2026/0361268 A1
(43) Pub. Date: Nov. 12, 2026

(54) SYSTEM AND METHOD FOR SPECTRUM SPLITTING ASSISTED PHOTOVOLTAIC COOLING AND DESALINATION

(71) Applicant: City University of Hong Kong, Kowloon (HK)

(72) Inventors: Wei WU, Tsim Sha Tsui (HK); Guangda LIANG, Mongkok (HK)

(21) Appl. No.: 19/529,444

(22) Filed: Feb. 4, 2026

Related U.S. Application Data
(60) Provisional application No. 63/768,206, filed on Mar. 7, 2025.

(51) Int. Cl. H02S 40/44; B01D 1/00; B01D 5/00; C02F 1/04; C02F 1/14; C02F 103/08; F24S 10/80; F24S 23/00

(52) U.S. Cl. CPC H02S 40/44; B01D 1/0035; B01D 1/0064; B01D 5/006; B01D 5/009; C02F 1/048; C02F 1/14; F24S 10/80; F24S 23/10; C02F 2103/08; C02F 2201/009

(57) ABSTRACT

A system for photovoltaic cooling and desalination. The system comprises: a filter for separating an incident solar energy into a first energy beam and a second energy beam; a photovoltaic module, comprising a photovoltaic cell for receiving and converting the first energy beam into electricity, the photovoltaic cell has a surface in thermal contact with untreated water such that heat generated at the photovoltaic cell during conversion evaporates the untreated water into vapor; a thermal absorbing module, comprising a thermal absorbing membrane for receiving and converting the second energy beam into heat, the thermal absorption membrane has a surface in thermal contact with untreated water such that heat generated at the thermal absorption membrane evaporates the untreated water into vapor. Each of the photovoltaic module and the thermal absorbing module further comprises a condenser component, for condensing the vapor to freshwater.

### CROSS-REFERENCE TO RELATED APPLICATIONS

This application claims priority to U.S. Provisional Application No. 63/768,206, filed Mar. 7, 2025, the contents of which are incorporated by reference herein in its entirety.

### TECHNICAL FIELD

The present invention relates to photovoltaic cooling. More particularly, the present invention relates to a system and method for photovoltaic cooling and desalination.

### BACKGROUND

The scarcity of water is a challenge to human health and well-being, and addressing it is one of the Sustainable Development Goals (SDGs). Producing clean water, especially desalination of brine, demands a substantial amount of electrical power. Desalination is considered as one of the most energy-intensive water treatment method, annually consuming over 75.2 TWh energy. The water-energy nexus represents a critical livelihood concern, particularly within economically developing regions. Traditional fossil fuels still account for approximately 80% of the global energy share. To mitigate the exacerbation of the greenhouse effect, reducing the reliance on fossil fuels is essential, making renewable energy a viable alternative. Harnessing solar energy, a clean and abundant resource, for power generation is one of the promising technologies that is rapidly advancing. The cumulative capacity of PV is projected to increase from 600 GW in 2020 to 8000 GW by the end of 2050.

Photovoltaic (PV) panels can only convert a portion of the incident sunlight into electricity and the maximum power conversion efficiency is 33% for a single-junction PV device. For current commercial PV panels, 72.16% of incident energy is lost as heat, causing an increase in PV temperature and a corresponding degradation in PCE. Therefore, implementing thermal management for PV panels to fully utilize the wasted heat energy can enhance the PCE and increase the utilization rate of solar energy.

Currently, some technologies are capable of harnessing the additional thermal energy for thermal-driven desalination of water while also managing heat. In most of these device-level attempts, dissipated heat is guided through the back board of PV module by thermal conducive material to membrane-based distillation components. However, these arrangements necessitate good thermal contact between the PV cell and thermal conductive materials, resulting in similar operating temperatures. This creates a dilemma: producing more fresh water requires a high-temperature heat source, which diminishes the efficiency of PV; conversely, increasing the efficiency of PV requires low operation temperatures, which reduces the thermal input for freshwater production.

The invention seeks to mitigate or to at least alleviate such a problem or shortcoming by providing a new or otherwise improved system for photovoltaic cooling and desalination.

### SUMMARY OF THE INVENTION

According to a first aspect of the present invention, there is provided a system for photovoltaic cooling and desalination, comprising: a filter configured to separate an incident solar energy into a first energy beam and a second energy beam; a photovoltaic module, comprising a photovoltaic cell configured to receive and convert a portion of the first energy beam into electricity, the photovoltaic cell having a surface in thermal contact with untreated water such that heat generated at the photovoltaic cell during conversion evaporates the untreated water into vapor; a thermal absorbing module, comprising a thermal absorbing membrane configured to receive and convert a portion of the second energy beam into heat, the thermal absorption membrane having a surface in thermal contact with untreated water such that heat generated at the thermal absorption membrane evaporates the untreated water into vapor; wherein each of the photovoltaic module and the thermal absorbing module further comprises a condenser component, the condenser component adapted to condense the vapour to freshwater.

In an embodiment, the condenser component comprises a plurality of condenser layers spaced apart from each other to enable the vapour to pass between and condense thereon.

In an embodiment, the condenser component comprises a frame structure configured to secure each of the plurality of condenser layers in place.

In an embodiment, each of the photovoltaic module and the thermal absorption module further comprises a fluid delivery unit configured to draw untreated water to evaporation sites associated with the condenser layers.

In an embodiment, the fluid delivery unit comprises a first plurality of capillary wicks, each attached to a back surface of a condenser layer, opposite to a condensing surface of a subsequent condenser layer.

In an embodiment, each capillary wick is spaced from the subsequent condenser layer by 2 mm to 8 mm.

In an embodiment, the fluid delivery unit further comprises two capillary wicks each attached to the surface of the photovoltaic cell and the thermal absorbing membrane.

In an embodiment, plurality of capillary wicks have a collective end immersed in an untreated water source, configured to draw the untreated water to the photovoltaic cell, the thermal absorbing membrane, and the plurality of condenser layers.

In an embodiment, the fluid delivery unit is further configured to collect and direct the freshwater out of the condenser component.

In an embodiment, the fluid delivery unit comprises a second plurality of capillary wicks each in contact with a condensing surface of a condenser layer configured to collect and direct the freshwater.

In an embodiment, the second plurality of capillary wicks have a collective end leading to a container for collecting the freshwater.

In an embodiment, the thermal absorbing membrane is an aluminium plate coated with a heat absorbing material selected from any one of black ink paint, resin paint, nanocarbon tube, or a combination thereof.

In an embodiment, thermal absorbing membrane is further covered with a transparent and low thermal conductivity material selected from any one of aerogel, glass, polymer or a combination thereof.

In an embodiment, each of the plurality of condenser layers is a metal plate.

In an embodiment, the filter is a spectral splitting filter configured to transmit photons in a wavelength ranging from 385 nm to 863 nm to the photovoltaic module, and reflect photons in a wavelength ranging from 863 nm to 2500 nm to the thermal absorber module.

According to a second aspect of the present invention, there is provided a method for photovoltaic cooling and desalination, comprising steps of: separating, by a filter, incident solar energy into a first energy beam and a second energy beam; directing the first energy beam to a photovoltaic module comprising a photovoltaic cell configured to receive and convert a portion of the first energy beam into electricity, and directing the second energy beam to a thermal absorbing module comprising a thermal absorbing membrane configured to receive and convert a portion of the second energy beam into heat; transporting untreated water into thermal contact with the photovoltaic cell and the thermal absorbing membrane such that heat generated thereby evaporates the untreated water into vapor; condensing, by a condenser component in each of the photovoltaic module and the thermal absorbing module, the vapor into freshwater.

In an embodiment, the condenser component comprises a plurality of condenser layers spaced apart from each other to enable the vapour to pass between and condense thereon.

In an embodiment, the transporting of untreated water to the photovoltaic module and the thermal absorption module is performed by a fluid delivery unit configured to draw the untreated water to evaporation sites associated with condenser layers in each module.

In an embodiment, the fluid delivery unit comprises a first plurality of capillary wicks, each attached to a back surface of a condenser layer, opposite to a condensing surface of a subsequent condenser layer.

In an embodiment, the method further comprising a step of collecting and directing the freshwater out of the condenser component by a second plurality of capillary wicks.

An embodiment of the present invention can be used for solar power generation and seawater desalination. The extraordinary performance in PV cooling, PV efficiency improvement, and freshwater production, enables the system of the present invention an attractive option for sustainable energy and clean water production in the future.

Compared with existing cogeneration of electricity and freshwater technologies, the system of the present invention exhibits higher temperature reduction, higher water production rate while maintain high solar conversion efficiency.

### BRIEF DESCRIPTION OF THE DRAWINGS

The invention will now be more particularly described, by way of example only, with reference to the accompanying drawings, in which:

FIG. 1 an illustration showing an embodiment of a photovoltaic cooling and desalination system, according to the present invention;

FIG. 2 is a schematic diagram showing the working mechanism of the photovoltaic cooling and desalination system of FIG. 1;

FIG. 3 is a schematic diagram of a simplified leaf structure, on which an embodiment of present invention takes reference;

FIG. 4 is a schematic diagram showing the partial structure of the system of FIG. 1, based on the inspiration of FIG. 3;

FIG. 5 is an illustration showing the design comparison between the evaporative PV cooling and multistage desalination (ECD) device and an embodiment of the spectral-splitting-synergized PV cooling and multistage desalination (SSCD), according to the present invention;

FIG. 6A is a graph showing the power conversion efficiencies (PCE) of different bandgap materials based on the Shockley-Queisser (S-Q) limit across the various configurations of FIG. 5, wherein the dots represent the highest efficiencies reported to date 16;

FIG. 6B is a graph showing thermal efficiency and temperature variations of PV with different bandgap materials across the various configurations of FIG. 5;

FIG. 6C is a graph showing PCEs and cell temperatures of the Cadmium Telluride (CdTe) for various airgap distances in the various configurations of FIG. 5;

FIG. 6D is a graph showing thermal efficiencies of the CdTe devices for various airgap distances in the various configurations of FIG. 5;

FIG. 7 is a graph showing reflectance and transmittance of the filter; absorbance of the thermal absorber; the spectrum of AM 1.5 according to an embodiment of the present invention, with the in-set photo showing a filter of the present invention under simulated sunlight exposure;

FIG. 8A is an exploded diagram showing core structure of a photovoltaic cooling and desalination system according to the present invention;

FIG. 8B is a schematic diagram of a lab testing bench for testing a photovoltaic cooling and desalination system, in accordance with an embodiment of the present invention;

FIG. 9A is a graph showing the velocity and vapor density contour of the first airgaps in the PV module and TA module of the 5,4S-SSCD, according to an embodiment of the present invention;

FIG. 9B is a graph showing PV temperatures of standalone PV, ECD, 5,4S-SSCD, and 10,10S-SSCD, respectively, according to an embodiment of the present invention;

FIG. 10A is a graph showing J-V curves of PV, ECD, and SSCD, according to an embodiment of the present invention;

FIG. 10B is a graph showing net mass changes and water production rate of PV, ECD, and SSCD, according to an embodiment of the present invention;

FIG. 10C is a bar chart showing ion chromatograph analysis of seawater and the water produced by an embodiment of a photovoltaic cooling and desalination system, in accordance with the present invention;

FIG. 11A is an illustration demonstrating energy flow for standalone PV, ECD, 5,4S-SSCD, and 10,10S-SSCD under simulated sunlight input;

FIG. 11B is a graph showing water production rate and maximum PV cell temperature for different solar intensities, in accordance with an embodiment of the present invention;

FIG. 11C is a graph showing comparison of water production rate and temperature reduction of an embodiment of the present invention with the prior art

FIG. 11D is a graph showing comparison of temperature reduction and cooling power of an embodiment of the present invention with other passive cooling methodologies;

FIG. 12A shows a schematic diagram of a field experimental setup of an embodiment of a system according to the present invention;

FIG. 12B is a graph showing temperature differences of standalone PV and 5,4S-SSCD across time, in accordance with an embodiment of the present invention;

FIG. 12C is graph showing normal output power of standalone PV and 5,4S-SSCD across various solar irradiance, in accordance with an embodiment of the present invention;

FIG. 13A is a graph showing mass change of water reservoir and water production rate during the experiment on an embodiment of the system according to the present invention;

FIG. 13B is a graph showing water production rate and maximum temperature drop between standalone PV and 5,4S-SSCD, during the experiment on an embodiment of the system according to the present invention, with the inset being a photo of collected freshwater;

FIG. 13C is graph showing accumulated solar energy and generated electricity from standalone PV and 5,4S-SSCD, during the experiment on an embodiment of the system according to the present invention

FIG. 14A is a schematic diagram showing a first stage of a PV module in the numeral model of ECD or SSCD;

FIG. 14B is a schematic diagram showing a first stage of a TA module in the numeral model;

FIG. 14C is a flowchart showing an iterative algorithm for the first stage of the PV and TA modules of FIGS. 14A and 14B;

FIG. 14D is a schematic diagram showing a multistage model for both the PV and TA modules of FIGS. 14A and 14B;

FIG. 14E is a flowchart showing an iterative algorithm for the PV and YA modules of FIGS. 14A and 14B;

FIG. 14F is a graph showing conductive heat transfer within airgaps of ECD and SSCD for various airgap distances;

FIG. 14G is a graph showing saturated vapor pressure for identical temperatures, different in low-temperature and high-temperature regions;

FIG. 14H is a graph showing vapor flux within airgaps of ECD and SSCD for various airgap distances;

FIG. 14I shows graphs demonstrating performance of ECD for various stage numbers, including (a) PV cell temperature, (b) PCE, and (c) Thermal efficiency;

FIG. 14J shows graphs demonstrating performance of SSCD for various stage numbers, including (a) PV cell temperature. (b) PCE. (c) Total thermal efficiency;

FIG. 14K shows graphs demonstrating the (a) temperature of the PV cell in SSCD, and (b) the water production rate of ECD;

FIG. 14L is a table showing bandgap, cut-off wavelength, and reported PCE of selected commercial solar cells utilised in an embodiment of the present invention;

FIG. 14M is a table showing global constants for a theoretical model, according to an embodiment of the present invention;

FIG. 14N is a table showing constants of a PV module for a theoretical model, according to an embodiment of the present invention;

FIG. 14O is a table showing constants of a TA module for a theoretical model, according to an embodiment of the present invention;

FIG. 15A shows illustrations demonstrating contact angles of the condenser (a) before hydrophobic coating, and (b) after hydrophobic coating.

FIG. 15B is a schematic diagram showing a preparation process of (a) a thermal absorber, and (b) a hydrophobic condenser, according to an embodiment of the present invention;

FIG. 15C shows scanning electron microscope (SEM) images of a capillary wick at the scale of (a) 100 μm, and (b) 40 μm, according to an embodiment of the present invention;

FIG. 15D is an exploded diagram showing structures of a PV module and a TA module, according to an embodiment of the present invention;

FIG. 15E is shows schematic three-dimensional structure of the frames, including (a) front view of the PV frame, (b) back view of the PV frame, (c) front view of the PV stage frame, (d) back view of the PV stage frame, (e) cross-section of the PV stage frame, (f) front view of the TA frame, (g) back view of the TA frame, (h) front view of the TA stage frame, (i) back view of the TA stage frame, and (j) cross-section of TA stage frame;

FIG. 15F shows photographic representations of (a) Aerogel, (b) PV cell, and (c) filter utilised in an embodiment of the present invention;

FIG. 15G shows photographic representations of (a) PV frame, (b) PV stage frame, (c) TA frame, (d) TA stage frame, and (e) back view of the TA stage frame, according to an embodiment of the present invention;

FIG. 16A shows graphs demonstrating temperatures of the standalone PV under (a) 0.5 kW/m2 illumination, (b) 1.0 kW/m2 illumination, and (c) 1.5 kW/m2 illumination, according to an embodiment of the present invention;

FIG. 16B shows graphs demonstrating stage temperatures of the ECD under (a) 0.5 kW/m2 illumination, (b) 1.0 kW/m2 illumination, and (c) 1.5 kW/m2 illumination, according to an embodiment of the present invention;

FIG. 16C shows graphs demonstrating stage temperatures of the 5,4S-SSCD, under the conditions including: (a) PV module under 0.5 kW/m2 illumination, (b) PV module under 1.0 kW/m2 illumination, (c) PV module under 1.5 kW/m2 illumination, (d) TA module under 0.5 kW/m2 illumination, (e) TA module under 1.0 kW/m2 illumination, and (f) TA module under 1.5 kW/m2 illumination, in accordance with an embodiment of the present invention;

FIG. 16D shows graphs demonstrating stage temperatures of the 10, 10S-SSCD, under the conditions including: (a) PV module under 0.5 kW/m2 illumination. (b) PV module under 1.0 kW/m2 illumination. (c) PV module under 1.5 kW/m2 illumination. (d) TA module under 0.5 kW/m2 illumination. (e) TA module under 1.0 kW/m2 illumination. (f) TA module under 1.5 kW/m2 illumination, in accordance with an embodiment of the present invention;

FIG. 16E shows infrared photos of (a) 5,4S-SSCD, and (b) 10,10S-SSCD under 1.0 kW/m2 illumination;

FIG. 16F shows infrared photos of various devices, including (a) schematic diagram of the standalone PV, (b) standalone PV cell temperature of different light intensities, (c) schematic diagram of the 5S-ECD, (d) PV cell temperature of different light intensities in 5S-ECD, (e) schematic diagram of the 5S-SSCD, (f) PV cell temperature of different light intensities in 5S-SSCD, (g) schematic diagram of the 10S-SSCD, and (h) PV cell temperature of different light intensities in 10S-SSCD;

FIG. 17A is a schematic diagram showing a numerical model and studied variables for use in an embodiment of the present invention;

FIG. 17B shows (a) velocity vectors and contours, and (b) vapor density contours of the 5,4S-SSCD device, which demonstrates the heat and mass transfer within the airgaps of an embodiment of the system, according to the present invention;

FIG. 17C is a graph showing vapor density within airgaps of 5,4S-SSCD device, according to an embodiment of the present invention;

FIG. 17D shows graphs demonstrating current density and power output for various scenarios, including (a) J-V curves of the standalone PV, (b) P-V curves of the standalone PV, (c) J-V curves of the ECD, (d) P-V curves of the ECD, (e) J-V curves of the 5,4S-SSCD, (f) P-V curves of the 5,4S-SSCD, (g) J-V curves of the 10,10S-SSCD, and (h) P-V curves of the 10,10S-SSCD, in accordance with an embodiment of the present invention;

FIG. 17E is a graph showing experimental PCE and correlations for PV cell under one-sun illumination for various temperatures;

FIG. 17F shows graphs demonstrating Real mass change for (a) 5S-ECD, (b) 5,4S-SSCD, and (c) 10,10S-SSCD;

FIG. 17G shows photographic representations of surface water droplets on condensers of 10,10S-SSCD, including (a) The 1st stage of the PV module, (b) The 5th stage of the PV module, (c) The 10th stage of the PV module, (d) The 1st stage of the TA module, (e) The 5th stage of the TA module, and (f) The 10th stage of the TA module;

FIG. 17H is a schematic diagram showing Energy flow of (a) the standalone PV, (b) the ECD, and (c) the SSCD;

FIG. 18A is a table showing maximum PV cell temperatures and corresponding PCEs, according to an embodiment of the present invention;

FIG. 18B is a table showing net mass change and water production rate for ECD, 5,4S-SSCD and 10,10S-SSCD;

FIG. 18C is a table showing collected stage water mass and stream-to-water efficiencies, according to an embodiment of the present invention;

FIG. 19A is a table showing standalone PV energy flow, according to an embodiment of the present invention;

FIG. 19B is a table showing the 5S-ECD energy flow;

FIG. 19C is a table showing the 5,4S-SSCD energy flow;

FIG. 19D is a table showing the 10, 10S-SSCD energy flow;

FIG. 20A is a table showing a comparison between photovoltaic electricity-water cogeneraters;

FIG. 20B is a table showing a summary of electrical output and water production rates for different types of solar-driven technologies;

FIG. 21A shows graphs demonstrating stage temperature of the SSCD, including (a) PV module for Day 1, (b) TA module for Day 1, (c) PV module for Day 2, (d) TA module for Day 2, (e) PV module for Day 3, and (f) TA module for Day 3; and

FIG. 21B is a diagram showing temperatures of the standalone PV and the 5,4S-SSCD for three days.

### DETAILED DESCRIPTION OF THE EMBODIMENTS

The cogeneration of electricity and water is one of the most promising solutions for addressing the energy-water nexus. However, previous photovoltaic generators faced limitations in enhancing both power conversion efficiencies and water production rates due to their thermally coupled configuration, which posed a multi-objective optimization dilemma. Embodiments of the present invention provides a bio-inspired spectral-splitting photovoltaic cooling strategy that reallocates spectral energy to thermally decouple electricity generation from multistage water desalination, thereby achieving high-performance thermal management and freshwater production simultaneously.

Remarkably, a prototype of the present invention demonstrates a significant electrical efficiency enhancement of 12.9% through a temperature reduction of 20.7 °C, along with a breakthrough water production rate of 2.9 kg/m2/h under one-sun condition. Compared to other passive cooling technologies, the spectral-splitting-synergized evaporative photovoltaic cooling approach of the present invention achieves a superior cooling power of ~750 W/m2, offering a method for regulating the temperature of photovoltaic panels. Furthermore, the device exhibits excellent thermal management performance, desalination capability, and robust applicability under practical working conditions. Overall, this methodology stands out as a promising solution to the pressing challenges of energy shortage and water scarcity. Rationally managing and fully utilizing the solar spectrum, it provides a viable path toward sustainable energy and water co-harvesting.

The energy-water nexus has emerged as a pivotal consideration in sustainable development, with urbanization-driven resource constraints currently impacting over 900 million people worldwide. Prevailing freshwater production technologies, including distillation, reverse osmosis (RO), and electroosmosis (EO), face fundamental limitations due to their energy-intensive operations and reliance on carbon-emitting power sources. Photovoltaic-integrated freshwater production systems offer a promising alternative by simultaneously reducing carbon emissions and energy demand through solar energy utilization. However, the practical implementation of these hybrid systems requires overcoming critical challenges in photovoltaic (PV) efficiency optimization. State-of-the-art crystalline silicon (c-Si) photovoltaic systems achieve 26% power conversion efficiency (PCE) under standard test conditions, yet approximately 74% of incident solar energy is dissipated as thermal losses. Field data from arid regions demonstrate that this thermalization elevates PV module temperatures beyond 60 °C during sustained operation, with experimental studies confirming a PCE degradation coefficient of 0.4-0.5%/° °C in c-Si cells. This temperature-dependent degradation of PCE underscores the critical need for advanced thermal management strategies to maximize energy production efficiency.

Conventional PV thermal management includes active and passive methods. Active cooling methods such as forced air/water convection incur parasitic energy losses, while passive radiative cooling systems demonstrate limited temperature reduction (ΔT<6 °C) and low cooling capacity (<100 W/m2). Sorption-based evaporative cooling can recover evaporated losses by harvesting atmospheric water, but its performance is restricted by environmental humidity and slow regeneration. More fundamentally, these thermal management strategies overlook the full utilization of the waste heat stream. Emerging electricity-water cogeneration devices address this fundamental challenge through thermally conductive interfacial layers that enable simultaneous heat extraction and desalination. These systems achieve concurrent PV temperature reduction and freshwater production by utilizing waste heat to drive distilling desalination processes. However, the thermal coupling between PV modules and desalination units creates an operational dilemma: maintaining lower interfacial temperatures for PV efficiency enhancement directly reduces water production rates, and vice versa. This fundamental conflict between thermal requirements for desalination and PV performance underscores the need for innovative solutions that decouple these interdependent processes.

Embodiments of the present invention provides a bio-inspired spectral-splitting-synergized PV cooling and multistage desalination (SSCD) method that reconfigures full-spectrum solar energy utilization. Drawing inspiration from tropical plant adaptations to high-radiation environments—particularly their dual strategies of infrared reflection and transpiration cooling—the SSCD architecture employs a biomimetic filter to spectrally decouple thermal contact while reflecting near-infrared (NIR) radiation (850-2500 nm). This design mimics the waxy leaf surfaces of desert plants that reflect excess infrared energy while transmitting photosynthetically active radiation.

The spectral-splitting device of the present invention achieves three critical functions: (1) reducing PV thermal load through NIR photon reflection, (2) maintaining high visible light transmission for photovoltaic conversion, and (3) directing reflected NIR energy to a dedicated thermal absorber. The rear-surface evaporative cooling module replicates plant transpiration mechanisms through capillary-driven water transport in micro structured “veins”, enabling passive heat dissipation analogous to stomatal regulation in leaves. The integrated multistage desalination module utilizes both PV waste heat and absorbed thermal energy via an enthalpy recovery architecture. Each stage contains condensation surfaces maintained at progressively lower temperatures through passive evaporative cooling, establishing a thermal gradient that drives continuous evaporation-condensation cycles.

Laboratory characterization under one-sun illumination (AM 1.5G, 21 °C ambient) confirms the superior performance of SSCD. The spectral-splitting filter reduces PV operating temperature to 44.9 °C compared to 65.6 °C of the uncooled counterpart, corresponding to a 12.9% PCE enhancement. Concurrently, the multistage desalination module achieves a freshwater production rate of 2.9 kg/m2/h, with total system efficiency (combined photovoltaic and thermal) reaching 206.4%. Energy analysis confirms 752 W/m2 cooling power via the integrated spectral splitting-evaporative cooling mechanism, representing a 70% improvement over state-of-the-art passive thermal management methods (440 W/m2). Outdoor field validation further substantiates the practical viability of SSCD, demonstrating stable electricity-water cogeneration over three days. The system achieves maximum power output enhancement of 11.1% compared to standalone PV cells while maintaining desalination rates above 2.58 kg/m2/h under outdoor irradiance. This invention achieves three key advancements: (1) a bio-inspired spectral management strategy that decouples PV efficiency from desalination thermal requirements, enabling significant temperature reduction and high-rate water production; (2) a leapfrog advancement in cooling power of passive PV thermal management; and (3) a new benchmark for hybrid system efficiency through integrated photovoltaic-thermal optimization. SSCD technology holds promise for solar-abundant, water-scarce regions, addressing the critical energy-water nexus through simultaneous electricity generation and sufficient water production. By productively utilizing PV thermal losses for desalination, this approach offers a scalable pathway toward sustainable energy-water solutions.

An embodiment of the present invention provides a synergic passive Photovoltaic (PV) cooling and multistage desalination device assisted by spectrum splitting. It is achieved by co-designing interfacial evaporation, capillary effect, and a specially designed structure.

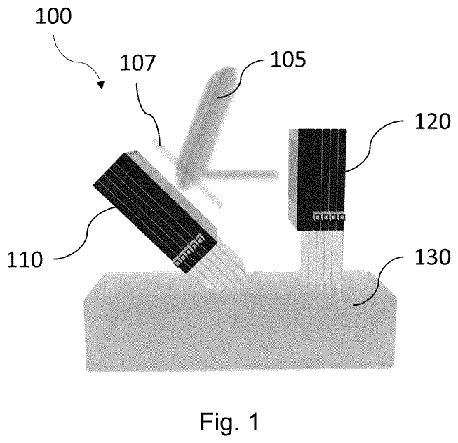

FIG. 1 schematically illustrates the design of an embodiment of the SSCD system. The system 100 comprises two functionally coupled units: the photovoltaic multistage desalination module (PV module) 110, which simultaneously generates electricity and recovers thermalization heat, and the thermal absorptive multistage desalination module (TA module) 120, dedicated to harvesting NIR solar energy. Incident sunlight 105 passes through a spectral-splitting filter 107, where above-bandgap photons are transmitted to the PV module 110, while below-bandgap photons are reflected to the TA module 120. Both modules are strategically positioned to maximize spectral energy utilization. Within each desalination stage, porous fibre wicks extend into an external seawater reservoir 130, enabling continuous capillary-driven transport of untreated seawater into the modules. Freshwater produced at each stage is collected via lateral discharge channels.

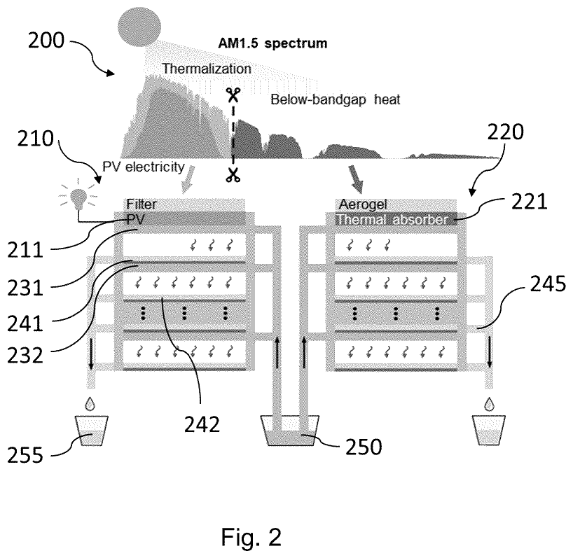

FIG. 2 elucidates the operational mechanism of PV cooling and electricity-water cogeneration in an embodiment of the SSCD system 200 of the present invention. Full-spectrum solar energy is spectrally divided based on the cut-off wavelength of the PV material, directing above-bandgap photons to the PV module 210 and below-bandgap photons to the TA module 220. Recombination heat from the PV panel 211 and de-excitation heat from the thermal absorber 221, which is in the form of a membrane, drive seawater evaporation within capillary wicks. The generated vapor condenses into freshwater on adjacent condensers, releasing latent heat. This condensation heat subsequently drives evaporation in the subsequent stage, establishing a cascading enthalpy recovery process that optimizes freshwater production.

To elaborate further, FIG. 2 shows that the system 200 comprises a PV module 210 and a thermal absorber (TA) module 220. A filter, such as a beam splitter, separates the incident solar energy onto a PV cell 211 and a thermal absorber 221. The thermal absorber 221 is an aluminium plate coated with heat-absorbing materials (such as black ink paint, resin paint, or nanocarbon tube), which can convert incident radiance into heat. An aerogel covers the thermal absorber to reduce the surface heat loss. More specifically, the PV cell 211 absorbs the above-band gap photons that can be transmitted through a spectral splitting filter and converts them into electricity. The below-band gap photons that cannot be absorbed are reflected by the filter into the thermal multistage desalination module.

Both the PV module 210 and the TA module 220 comprise an evaporator that operates in conjunction with a condenser. In an embodiment, the evaporator comprises a plurality of capillary wicks 231, 232 or tubes. The collective end of these wicks 231, 232 is immersed in seawater 250, which is then directed throughout their entire length and held therein. The water retained in the capillary wicks 231, 232 evaporates into vapour due to the heat absorbed from the PV cell 211 or the thermal absorber 211.

The condensers of both the PV module 210 and the TA module 220 each comprise a plurality of condenser plates 241, 242, with each plate 241/242 positioned opposite a preceding capillary wick 231/232. This configuration allows water vapor evaporated from the wick 231 to condense directly on the opposing plate 241. In practice, a subsequent capillary wick 232 is attached to the back side of each condenser plate 241. Due to the temperature gradient, the vapor pressure at the wick exceeds that of the condenser layer to which it is attached to, driving the vapor towards the opposing condenser layer where it condenses into liquid freshwater 255. Condensed freshwater from all condenser plates is guided via channels 245 to an external collection container within the system 200.

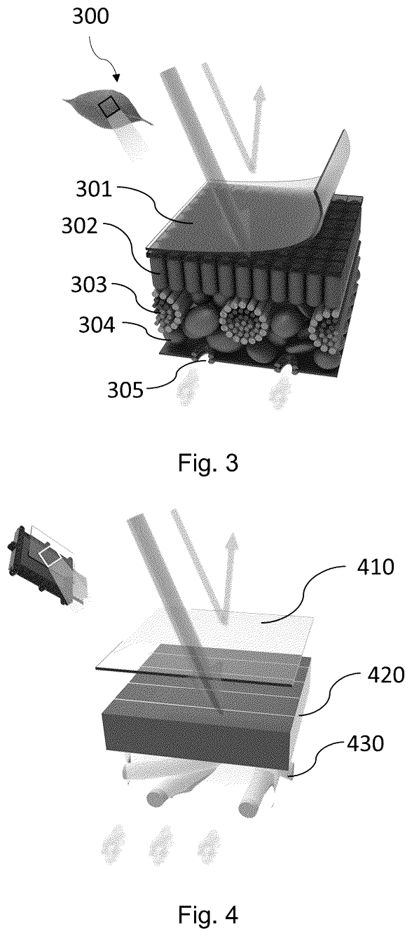

Natural plants offer sophisticated strategies for managing solar energy under thermal stress. As illustrated in FIG. 3, the canonical structure of a leaf 300 comprises the cuticle 301, palisade cells 302, veins 303, spongy cells 304, and stomata 305. The cuticle 301, enriched with intracuticular waxes, forms a reflective layer to reduce solar thermal absorption while permitting visible light transmission for photosynthesis. Root-absorbed water ascends through vascular veins 303 via capillary action, enabling transpiration-driven evaporative cooling through stomatal pores.

Inspired by these natural thermoregulatory mechanisms, the SSCD system of the present invention partially emulates key structural and functional attributes of waxy leaves, as shown in FIG. 4. The design replicates the spectral selectivity of plant leaves through a below-bandgap light-reflective filter 410, which transmits above-bandgap photons to the PV panel 420 while alleviating its thermal load. A capillary fibre wick 430 attached to the PV backplate mimics plant vascular transport, delivering coolant from a reservoir to absorb and dissipate PV waste heat via evaporation.

### Theoretical Basis for Devices

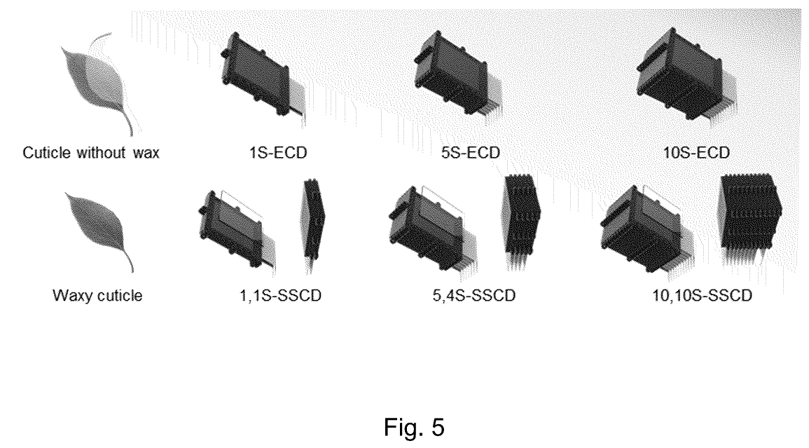

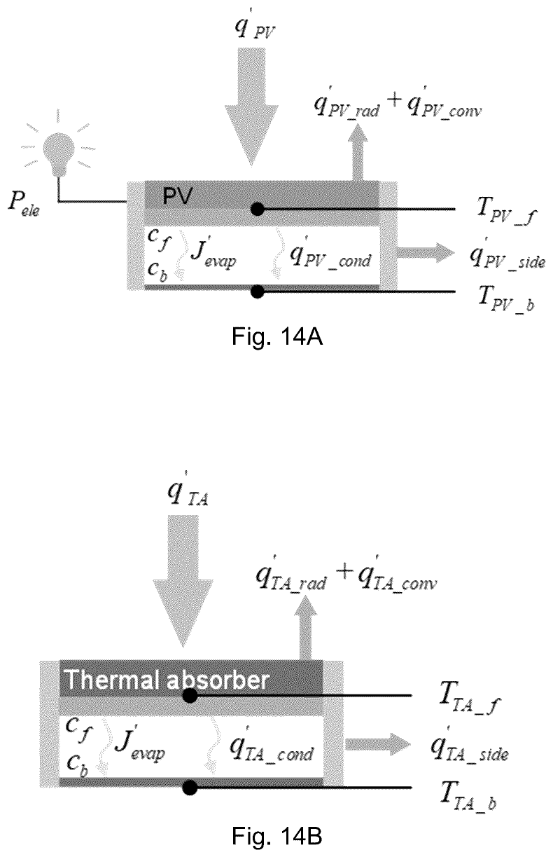

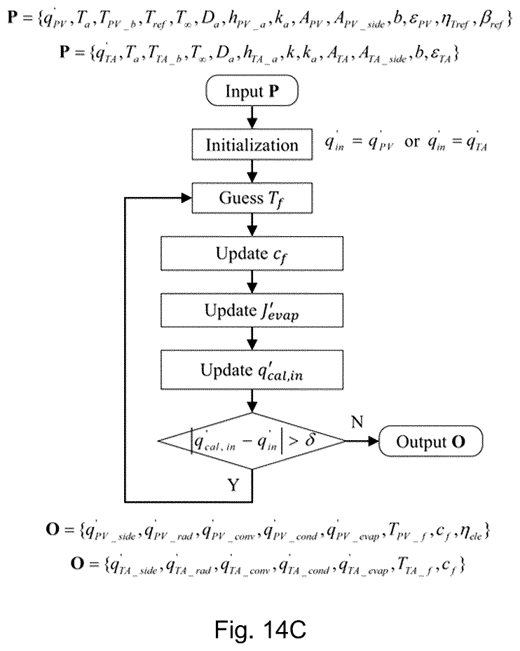

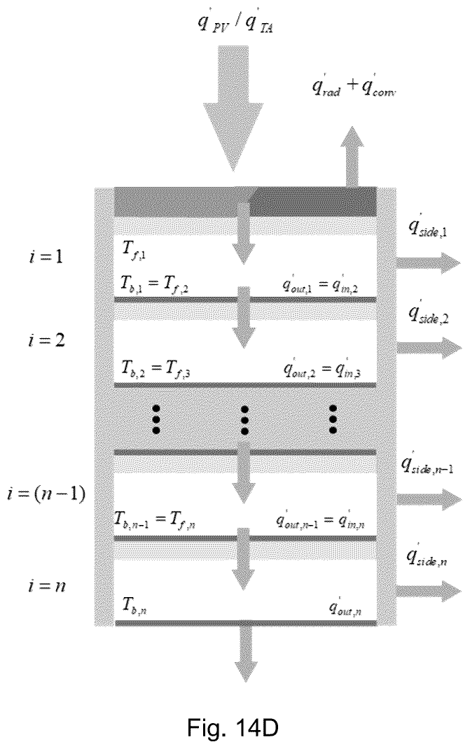

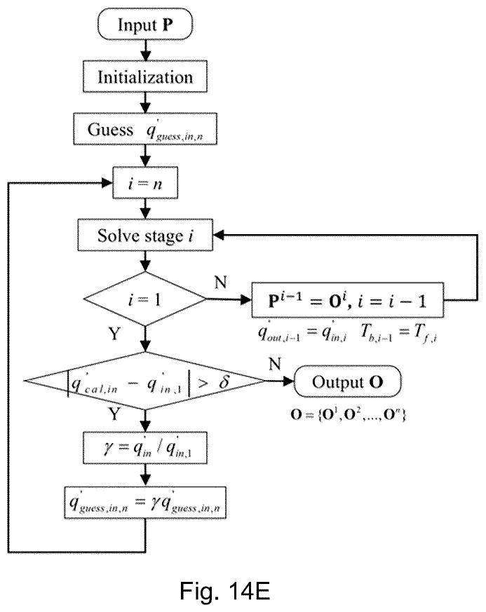

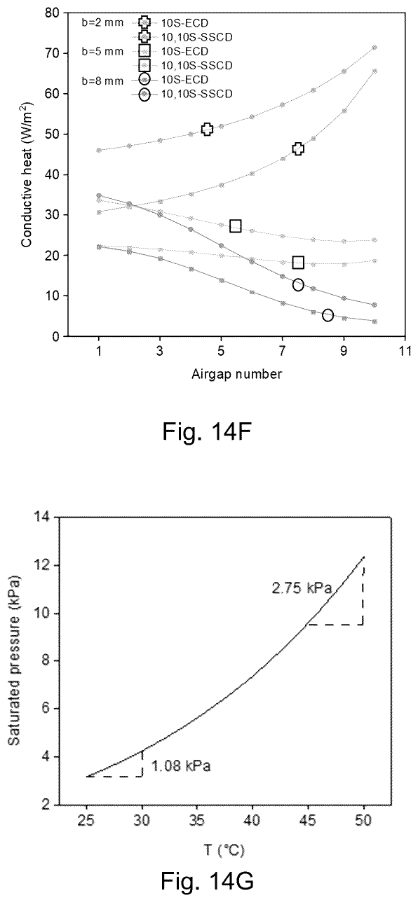

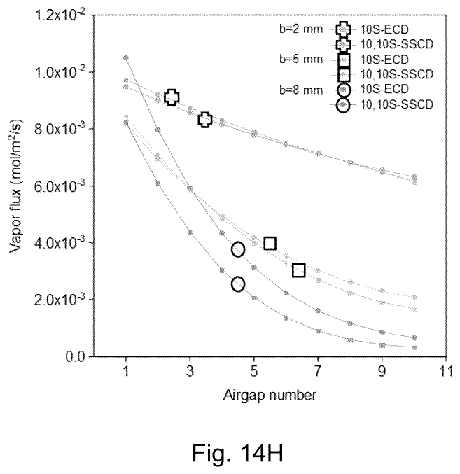

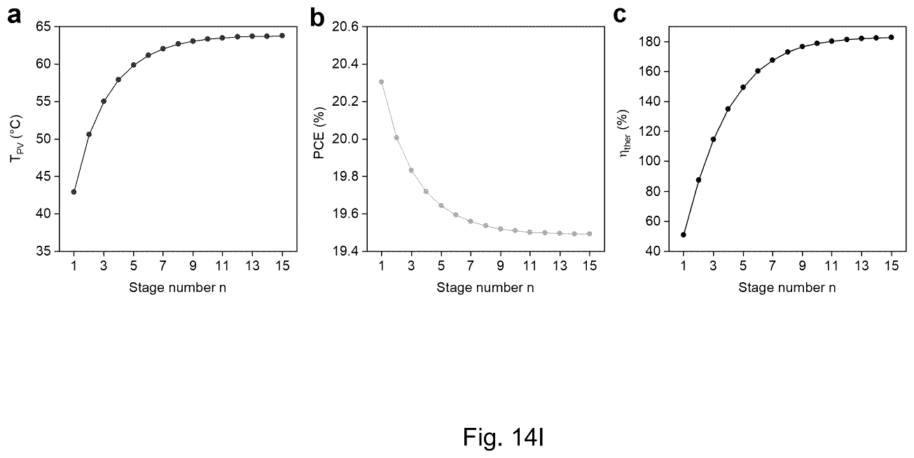

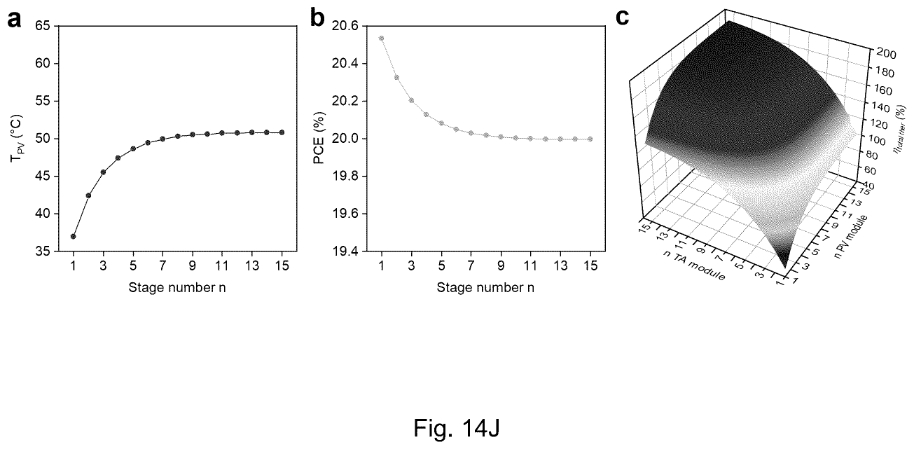

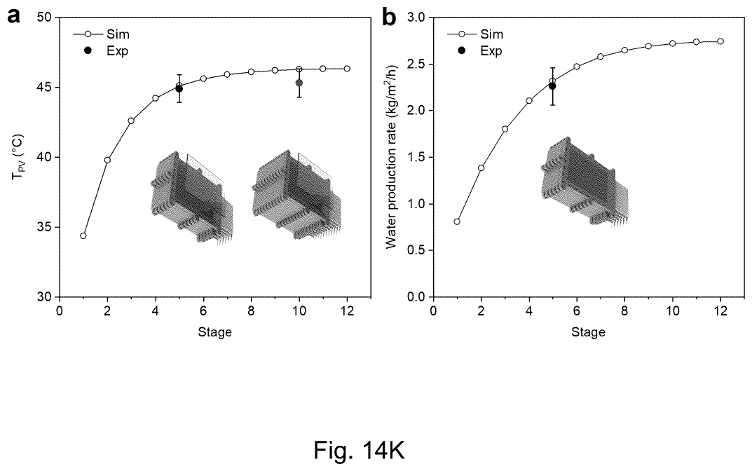

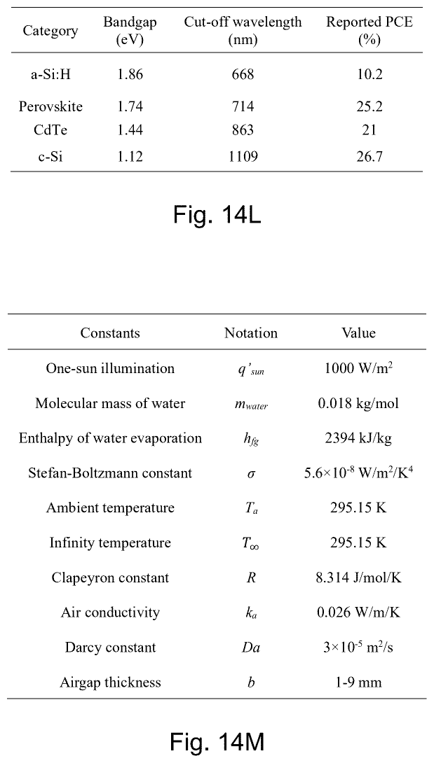

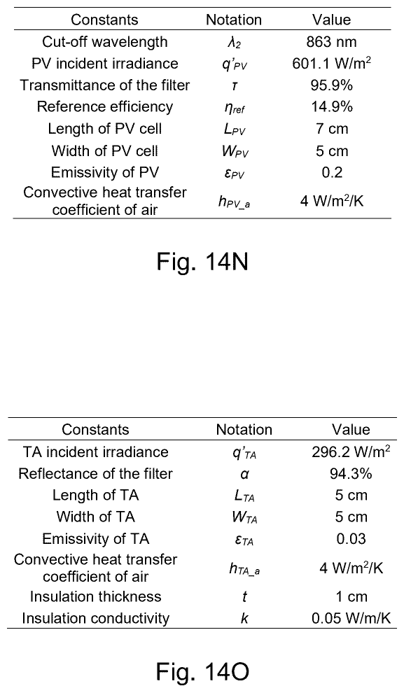

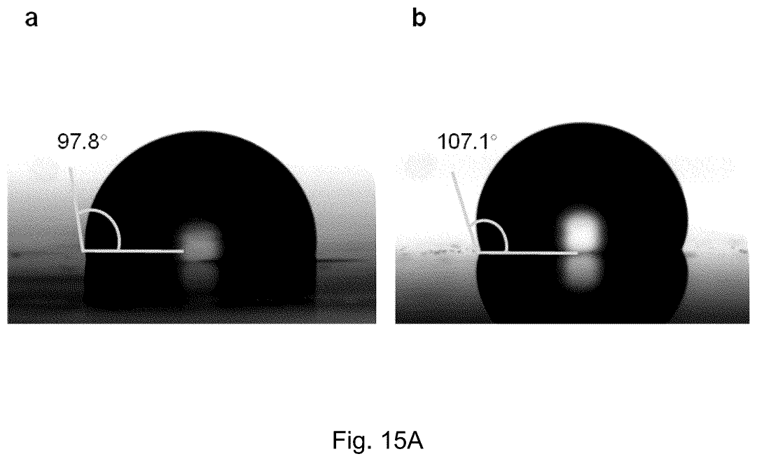

Leaves with waxy surfaces can regulate plant temperature by reflecting solar radiation. This concept serves as a guiding principle for device design, supported by mathematical modelling, as shown in FIGS. 14A to 14E. To systematically compare performance across PV materials and configurations, a non-spectral-filtered counterpart termed the evaporative PV cooling and multistage desalination (ECD) device is developed, as schematically depicted in FIG. 5.

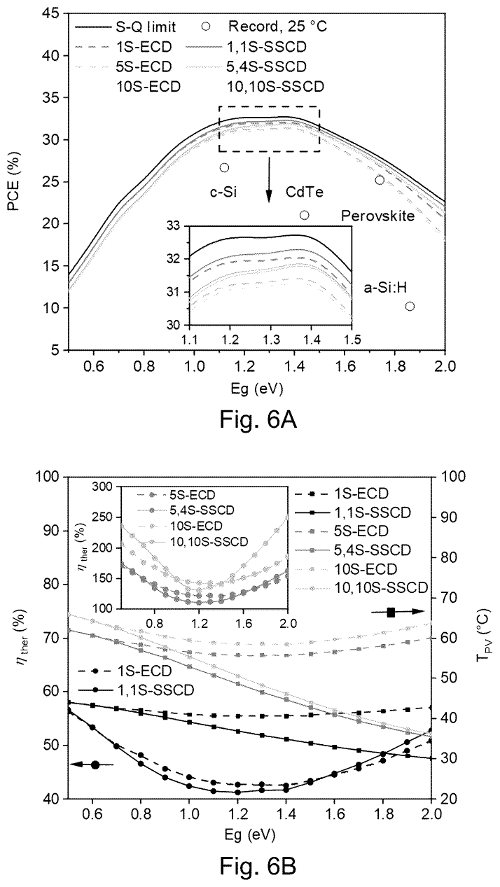

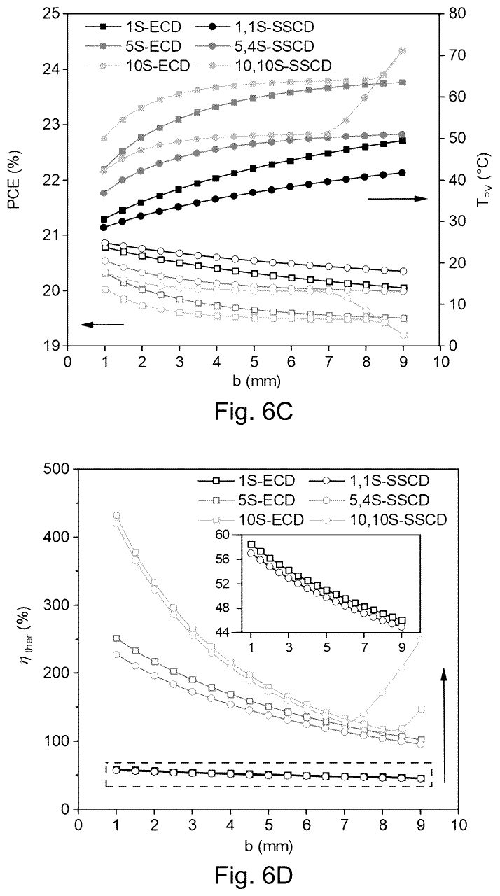

In the proposed biomimetic cogeneration system, SSCD can effectively enhance the PCEs across the full spectrum, compared with ECD, as shown in FIG. 6A. For large bandgap materials, a significant portion of below-bandgap energy is wasted. Filtering this energy can effectively prevent temperature increases, thereby improving PCE. As the bandgap increases, SSCD exhibits a more pronounced cooling capability, as shown in FIG. 6A. Increasing the number of desalination stages for both ECD and SSCD increases thermal resistance and thus decreases PCE on the one hand, but on the other hand, it enhances the number of thermal energy recovery, thereby improving thermal efficiency, as shown in FIG. 6B. The thermal efficiency ηₜₕₑᵣ can be calculated from the water production rate and is given by:

$${η}_{t h e r} = \frac{\dot{m} {h}_{f g}}{{\dot{q}}_{s u n} A} \qquad Equation 1$$

where \dot{m} is the mass change rate of water in kg/s, h_{fg} is the enthalpy of water evaporation at 45 °C (2394 KJ/kg), \dot{q}ₛᵤₙ is the solar irradiance in W/m2, and A is the irradiated area.

Notably, a distinct crossover in thermal efficiency is observed between ECD and SSCD configurations as the bandgap increases. For PV materials with smaller bandgaps (employing spectral filters of larger cutoff wavelengths), a substantial portion of solar energy is dissipated as thermalization heat within the PV module, collectively elevating stage temperatures and enhancing the saturated vapor fraction in airgaps. Consequently, ECD configurations exhibit superior thermal efficiency under these conditions. Conversely, when PV materials with sufficiently large bandgaps are adopted, the SSCD system predominantly utilizes below-bandgap energy in the TA module. The thermal efficiency of SSCD becomes increasingly pronounced with incremental stage numbers due to intensified thermal energy reutilization. To achieve an optimal balance between minimizing PV thermalization losses and maximizing thermal efficiency, SSCD architectures with higher stage counts demonstrate superior overall performance. Therefore, among the candidate materials, those with larger bandgap energies are prioritised over crystalline silicon (c-Si) solar cells. Perovskite solar cells exhibit high sensitivity to ambient moisture, resulting in efficiency degradation that disqualifies them as viable candidates for electricity-water cogeneration. Cadmium Telluride (CdTe) demonstrates superior suitability for this application. Hence, reported CdTe PV efficiency was selected for further theoretical analysis. Details of which are shown in FIG. 14L.

The airgap dimension critically influences thermal-electrical performance in the desalination module. Within each stage, thermal energy transfers via conduction, while expanded airgaps elevate thermal resistance, impeding heat dissipation from the PV backplate and consequently raising PV temperatures while degrading PCE across all configurations, as illustrated in FIG. 6C. The 1S-ECD system maintained minimal temperature rise (ΔT<13 °C) and PCE attenuation at airgaps below 7 mm, outperforming multistage counterparts. Beyond this threshold, heat accumulation in upstream stages severely obstructed backward thermal transfer (FIG. 14F), triggering abrupt PV temperature surges (>20 °C) and PCE collapse in multistage systems. Comparative analysis (FIG. 6D) reveals higher thermal efficiencies in unfiltered ECD configurations (1S-ECD: 58% peak; 5S-ECD: 251% peak) compared to SSCD counterparts at equivalent airgaps. This disparity arises from elevated stage temperatures in ECDs, which amplify vapor pressure differentials (FIG. 14H), albeit at the expense of PCE degradation. While lateral heat losses generally reduce thermal efficiency with airgap expansion, anomalous efficiency recovery emerges beyond 7 mm in 10-stage systems. Here, suppressed thermal transfer in upstream stages induces localized temperature spikes, significantly enhancing saturated vapor differentials (FIG. 14H). These upstream stages dominate vapor flux generation, creating an efficiency rebound at the cost of unbalanced electrical-thermal performance. These results emphasize the necessity for stage-airgap co-optimization to balance vapor pressure enhancement and parasitic thermal dissipation.

Theoretical modelling of bio-inspired spectral-splitting-synergized PV cooling and multistage desalination device

To thoroughly comprehend the fundamentals of heat and mass transfer and to optimize the performance of PV cooling and the electricity-water cogeneration, a theoretical model is developed to elucidate the physical processes of energy and mass transfer occurring between the solar cell, water, and the surrounding environment. The model employs an iterative algorithm, which includes the PV efficiency degradation caused by temperature rise. It applies to both evaporative PV cooling desalination (ECD) devices and bio-inspired spectral-splitting-synergized PV cooling and multistage desalination (SSCD) devices. The model can guide experimental design, validate experimental results, and anticipate optimal outcomes. In this section, we introduce the physical processes involved, the specific implementation algorithms, and provide a detailed discussion of the design and analysis process.

For traditional photovoltaic power generation, the incident energy is entirely derived from solar radiation, which can be represented by,

$${q}_{solar}^{′} = {q}_{P V}^{′} \qquad ( S1 )$$

where

$${q}_{P V}^{′}$$

is the energy obtained by the PV panel per unit area.

For the spectral-splitting device, the incident solar energy is separated into two parts by the filter,

$${q}_{solar}^{′} = {q}_{P V}^{′} + {q}_{T A}^{′} \qquad ( S2 )$$

where

$${q}_{P V}^{′}$$

is the energy obtained by the PV module and q′_{TA} is the energy obtained by the thermal absorptive (TA) module.

For PV in ECD or SSCD, the first stage is shown in FIG. 14A.

The incident energy of SSCD is related to the transmittance of the filter, and is given by,

$${q}_{P V}^{′} = {\int }_{{λ}_{1}}^{{λ}_{2}} τ ( λ ) \cdot {AM}_{1.5} ( λ ) d ( λ ) \qquad ( S3 )$$

where from λ₁ to λ₂ is calculated wavelength range, and λ₂ is the cut-off wavelength in the current study. τ is the transmittance at a particular wavelength, and AM_{1.5} is the solar energy at a wavelength of λ for the AM1.5 standard spectrum.

During power generation in both ECD and SSCD, a portion of the incident light energy is converted into electrical energy, while the remainder is dissipated as heat, which can be represented by,

$${q}_{P V} = {P}_{ele} + {A}_{P V} ( {q}_{PV\_rad}^{′} + {q}_{PV\_conv}^{′} + {q}_{PV\_cond}^{′} + {q}_{PV\_evap}^{′} ) \qquad ( S4 )$$

where A_{PV} is the effective area of PV cells.

The power generated is related to the incident light intensity and the power conversion efficiency (PCE),

Pₑₗₑ=I·ηₑₗₑ (S5)

where I is the solar intensity, and the solar intensity here is equal to the incident solar energy

$${q}_{P V}^{′} .$$

To simplify the model, a linear relationship is employed to calculate the PCE at different temperatures1,

ηₑₗₑ=η_{Tref}[1-β_{ref}(T_{PV_f}+T_{ref})] (S6)

where η_{Tref} represents the efficiency at the reference temperature, β_{ref} is the reference temperature coefficient, and T_{ref} is the reference temperature, typically taken as 25 °C.

For single-junction solar cells, Shockley and Queisser established a theoretical efficiency limit2,3 that does not exceed 33% under one-sun conditions. Fundamentally, the temperature coefficient of the maximum efficiency of PV cells is related to the bandgap. In this work, we employ an analytical solution4 of the temperature coefficient for the calculation of PCE.

The specific value of β_{ref} is given by β(E_{g}),

β_{ref}=β(E_{g}) (S7)

Therefore, in this model, the theoretical maximum PCE of the PV cell as a function of temperature can also be derived, as shown in FIG. 2b.

The radiative heat loss of the PV module is given by,

$${q}_{PV\_rad}^{′} = {ε}_{P V} σ ( {T}_{PV\_f}^{4} - {T}_{∞}^{4} ) \qquad ( S8 )$$

where the Stefan-Boltzmann constant is σ=5.67×10⁻⁸ Wm⁻²K⁻⁴, T_{PV_f} is the front side temperature of the PV cell, T_{∞}, is the sky temperature, and ε_{PV} is the emissivity of the PV cell.

The convective heat loss is,

$${q}_{PV\_conv}^{′} = {h}_{PV\_a} ( {T}_{PV\_f} - {T}_{a} ) \qquad ( S9 )$$

where h_{PV_a} is the convective heat transfer coefficient between air and PV cell surface, and Tₐ is the ambient temperature.

The conductive heat loss is expressed as,

$${q}_{PV \_ cond}^{′} = - {k}_{a} \frac{dT}{dx} = {k}_{a} \frac{{T}_{PV \_ f} - {T}_{PV \_ b}}{b} \qquad ( S10 )$$

where kₐ is the thermal conductivity of air, T_{PV_b} is the back temperature of the stage of the PV module, and b is the airgap distance.

And the energy loss due to the evaporation of water,

$${q}_{PV \_ evap}^{′} = {m}_{water} {hJ}_{evap}^{′} \qquad ( S11 )$$

where m_{water} is the evaporated water by the PV module, h is the latent heat of the water, and

$${J}_{evap}^{′}$$

is the vapor transportation rate.

For steady-state two-dimensional vapor transfer, Fick's law can be used to simplify the model,

$${J}_{evap}^{′} = - {D}_{a} \frac{dc}{dx} \approx {D}_{a} \frac{{c}_{f} - {c}_{b}}{b} \qquad ( S12 )$$

where Dₐ is the diffusivity of water vapor in air, and the saturated vapor pressure of the front c_{f} and back c_{b} are temperature-dependentc(T).

In the back of 1st stage, energy conservation of the condenser is given as,

$${q}_{{PV}_{b} , in} = {q}_{{PV}_{b} , out} = {A}_{PV} \times ( {q}_{PV\_evap}^{′} + {q}_{PV\_cond}^{′} ) - {A}_{PV \_ side} \times {q}_{PV\_side}^{′} \qquad ( S13 )$$

where A_{PV_side} is the side area of the PV module, and

$${q}_{PV\_side}^{′}$$

is the heat loss through the side area.

The side heat loss of the PV module is in the form of convective heat transfer, and the surface temperature of the side is simplified using an average temperature,

$${q}_{PV\_side}^{′} = \frac{0.5 \times ( {T}_{PV \_ f} - {T}_{PV \_ b} ) - {T}_{a}}{{R}_{PV \_ side}} \qquad ( S14 )$$

where R_{PV_side} is the thermal resistance of the side frame,

$${R}_{PV \_ side} = \frac{1}{{h}_{PV \_ a}} \qquad ( S15 )$$

Similarly, the first stage of the TA module in the SSCD device is demonstrated in FIG. 14B.

The incident energy of the TA module is related to the reflectance of the filter, and is given by,

$${q}_{TA}^{′} = {\int }_{{λ}_{2}}^{2500} α ( λ ) \cdot {AM}_{1.5} ( λ ) d ( λ ) \qquad ( S16 )$$

where α is the reflectance of the filter at the wavelength λ, and the upper limit of wavelength is 2500 nm, considering negligible energy for wavelengths larger than 2500 nm.

Assume that all incident energy of the TA module is converted into heat,

$${q}_{TA}^{′} = {q}_{TA \_ rad}^{′} + {q}_{TA \_ conv}^{′} + {q}_{TA \_ cond}^{′} + {q}_{TA \_ evap}^{′} \qquad ( S17 )$$

The radiative heat loss of the TA module is calculated by,

$${q}_{TA \_ rad}^{′} = {ε}_{TA} σ ( {T}_{TA \_ f}^{4} - {T}_{∞}^{4} ) \qquad ( S18 )$$

where T_{TA_f} is the front side temperature of the PV cell, and ε_{TA} is the emissivity of the thermal absorber.

The surface convective heat loss is expressed as,

$${q}_{TA \_ conv}^{′} = {h}_{TA \_ a} ( {T}_{TA \_ f} - {T}_{a} ) \qquad ( S19 )$$

where h_{TA_a} is the convective heat transfer coefficient between air and the thermal absorber.

The surface conductive heat loss is given by,

$${q}_{TA \_ cond}^{′} = - {k}_{a} \frac{dT}{dx} = {k}_{a} \frac{{T}_{TA \_ f} - {T}_{TA \_ b}}{b} \qquad ( S20 )$$

where T_{TA_b} is the back temperature of the stage of the TA module, and b is the distance between the TA frontside and backside.

And the energy loss due to the evaporation of water,

$${q}_{TA \_ evap}^{′} = {m}_{water} {hJ}_{evap}^{′} \qquad ( S21 )$$

In the back of 1st stage, energy conservation of the condenser is given as,

$${q}_{{TA}_{b} , in} = {q}_{{TA}_{b} , out} = {A}_{TA} \times ( {q}_{TA \_ evap}^{′} + {q}_{TA \_ cond}^{′} ) - {A}_{TA \_ side} \times {q}_{TA\_side}^{′} \qquad ( S22 )$$

where A_{TA} is the area of thermal absorber, A_{PV_side} is the side area of the TA module, and

$${q}_{TA \_ side}^{′}$$

is the heat loss through the side area.

Similarly, for the side loss of the TA module,

$${q}_{TA \_ side}^{′} = \frac{0.5 \times ( {T}_{TA \_ f} + {T}_{TA \_ b} ) - {T}_{a}}{{R}_{TA \_ side}} \qquad ( S23 )$$

where R_{side} is the thermal resistance of the side insulation, and the thermal insulation has been applied to the TA module, its side heat losses are in the form of both convective and conductive heat transfer.

$${R}_{TA \_ side} = \frac{1}{{h}_{TA \_ a}} + \frac{t}{k} \qquad ( S24 )$$

The thickness and the thermal conductivity of insulation material are expressed as t and k.

Those variables mentioned above are solved by a stage iterative algorithm, as shown in FIG. 14C.

This algorithm is applicable to both the PV and TA modules, taking

$${q}_{PV}^{′} or {q}_{TA}^{′}$$

as modular power input

$${q}_{in}^{′} .$$

initialized with an input state value P, followed by updating the states using an initial guessed temperature T. Subsequently, the whole stage is solved with guess temperature T. The calculated input power

$${q}_{cal , in}^{′}$$

is compared with the real modular input

$${q}_{in}^{′} .$$

When the error δ converges, it can be considered that the stage has been solved, and the output state values O are generated.

For the multistage model, it is illustrated in FIG. 14D.

The input for the first stage is

$${q}_{PV}^{′} or {q}_{TA}^{′} .$$

The connection between consecutive stages is defined by,

$${q}_{out , i - 1}^{′} = {q}_{in , i}^{′} \qquad ( S25 )$$

$${T}_{b , i - 1} = {T}_{f , i} \qquad ( S26 )$$

Thus, the states of multiple stages can be iteratively solved using the method for a single stage. The algorithm is shown in FIG. 14E.

The input power

$${q}_{in , n}^{′}$$

for the n-th stage is unknown. During the calculation, a guess value

$${q}_{guess , in , n}^{′}$$

is initially used to compute the state of the i-th stage. The algorithm for computing the i-th stage is similar to that used for the first stage described earlier. The states of all modules are successively calculated through iterative application of equations (S25) and (S26). The computed input energy for the first stage is compared with the actual input energy. When the error is significant, a scaling factor γ is applied to adjust the initial guess

$${q}_{guess , in , n}^{′}$$

to accelerate convergence.

FIG. 14F illustrates three airgap distances (b=2, 5, and 8 mm) to delineate variations in interstage heat transfer behavior, where the total stage heat flux in SSCD systems corresponds to the summation of heat fluxes from both the PV module and TA module (e.g., for the fifth airgap,

$${q}_{SSCD \_ cond \_ 5}^{′} = {q}_{PV \_ cond \_ 5}^{′} + {q}_{TA \_ cond \_ 5}^{′} ) .$$

Within airgaps, thermal energy is predominantly transferred between stages via conduction, governed by Equations S10 and S20. At b=2 mm, lower thermal resistance allows heat flux to propagate efficiently across all stages, with heat dissipation predominantly occurring in downstream stages. When the airgap distance increases to 5 mm, elevated thermal resistance concentrates conductive heat transfer in the first five stages. At b=8 mm, hindrance heat transfer to downstream stages results in steeper thermal gradients, as heat accumulates locally.

Under identical temperature differentials, the saturated vapor concentration gradient becomes more pronounced in high-temperature regions (FIG. 14G). This mechanism directly implies that elevated stage temperatures could enhance water production, thereby improving thermal efficiency.

The water vapor flux within airgaps, governed by Equation S12, depends on both temperature gradients and geometric spacing. Following an evaluation approach analogous to that in FIG. 14F, the vapor flux distributions for ECD and SSCD configurations are compared in FIG. 14H. At b=2 mm, minimal differences in vapor flux are observed between ECD and SSCD across all stages. At b=5 mm, SSCD exhibits superior mass transfer performance in downstream stages compared to ECD. When b increases to 8 mm, vapor transport in upstream stages dominates, counteracting the adverse effects of linearly growing airgap resistance and ultimately enhancing thermal efficiency.

Both ECD and SSCD can effectively reduce the temperature of the PV cell. However, as the number of stages increases, the recoverable heat decreases. Additionally, the more complex structure increases thermal resistance, leading to a reduction in PCE.

As the stage number increases, the temperature of the PV cell tends to stabilize at 64 °C when n exceeds 9. The marginal change in thermal efficiency is minimal as n increases, with a maximum efficiency of 182%. When n exceeds 5, a maximum efficiency of 75% can be achieved, and when n exceeds 10, 97% of the maximum efficiency is achieved.

In the SSCD device, the PCE and the temperature of the PV cell are only related to the number of stages n in the PV module, as shown in parts (a) and (b) in FIG. 14J. When the number of stages in the PV module exceeds 8, the temperature of the PV cell approaches 51 °C. The total thermal efficiency, which is the sum of the thermal efficiencies of the PV module and the TA module, is related to the number of stages n in both modules, as depicted in part (c) of FIG. 14J. It can be observed that the total thermal efficiency plateaus at 187%. When n is 5 for the PV module and 4 for the TA module, the efficiency reaches 75% of the maximum value. There are multiple combinations possible. Considering the materials used in the experiments and the comparability with ECD, other combinations are not considered. When n is 10 for both modules, the efficiency reaches 98% of the maximum value.

The current theoretical model has been validated by experimental results. The experimentally measured PCE, temperature coefficient of CdTe, and other parameters were input into the model, and the results showed that the calculated temperature of the PV cell and the water production rate of the device are accurate.

Numerical modeling for airgaps using multiphysics method.

To investigate the heat and mass transfer within the airgaps, a numerical model is developed in COMSOL Multiphysics. The study domain is the airgaps shaped by the frame. The cross-sectional shape of the frame is extracted and simplified for analysis. A 2D model is employed. The dimensions of the PV module airgaps are 70 mm×5 mm, and the TD module airgaps are 50 mm×5 mm. The numbers of mesh for two modules are 4,338 and 5,400, respectively.

The physical process involved in airgaps,
(1) Seawater in the evaporator evaporates and transports as vapor into the airgaps.
(2) Hot steam condenses on the surface of the condenser.
(3) Free air enters from the evaporator and, due to the sealing of the structure, exits through the bottom surface.
(4) There is heat transfer at the front and back boundaries of the airgaps.

Considering the multiple physical processes involved in the study and the objectives of our research, the numerical model is developed based on the following assumptions,
(1) The air entering the gap is saturated; condensation occurs at the boundaries of the air gap.
(2) Air flows into the gap from the evaporator and exits at the bottom, remaining in a laminar state due to its low velocity.
(3) The process is isobaric.
(4) Gravity is considered.

Ignoring the heat conduction and heat radiation processes within the studied airgap, its energy balance equation is given by,

ρCₚu·∇T+∇q=Q+QH (S27)

q=−k∇T (S28)

Q_{H}=−(C_{p,v}−C_{p,a})gw·∇T (S29)

where ρ is the air density, Cₚ is the specific heat capacity at constant pressure, T is the absolute temperature, u is the velocity vector, q is the heat flux by conduction, Q is heat sources, Q_{H} is diffusive flux of thermal enthalpy due to the rate of change of air and vapor in moist air, C_{p,v} is the specific heat capacity at constant pressure of vapor, C_{p,a} is the specific heat capacity at constant pressure of air, and gw is the vapor flux by diffusion.

For laminar flow,

$$ρ ( u \cdot ∇ ) u = ∇ \cdot [ - pI + K ] + ρ g \qquad ( S30 )$$

$$∇ ( ρ u ) = 0 \qquad ( S31 )$$

$$K = μ ( ∇ u + {( ∇ u )}^{T} ) - \frac{2}{3} μ ( ∇ \cdot u ) I \qquad ( S32 )$$

where p is pressure, I is the identity matrix, K is the viscous stress tensor, and u is dynamic viscosity.

The mass transfer process involves moist steam flow,

M_{V}u·∇_{Cv}+∇·gw=G (S33)

gw=−M_{V}D∇c_{V} (S34)

c_{V}=φ_{W}cₛₐₜ (S35)

where M_{V} is the molar mass of water vapor, φ_{W} is the relative humidity, cₛₐₜ is the vapor saturation concentration, D is the vapor diffusion coefficient in air, gw is the vapor diffusive flux, and G is the moisture source.

The inlet of the moist steam is an open boundary and is defined by the upstream temperature and upstream humidity,

$$- n \cdot gw = ρ ( {ω}_{V} - {ω}_{ustr} ) u \cdot n \qquad ( S36 )$$

$${ω}_{ustr} = \frac{{M}_{V} {c}_{ustr}}{ρ} \qquad ( S37 )$$

$${c}_{ustr} = {ϕ}_{W , ustr} {c}_{sat} ( {T}_{ustr} ) \qquad ( S38 )$$

where ω_{V}, ωᵤₛₜᵣ are vapor mass fraction of the computational volume and upstream, respectively. cᵤₛₜᵣ is the upstream vapor density, φ_{W,ustr} is the upstream relative humidity, and Tᵤₛₜᵣ is the upstream temperature.

The airgaps in the module are coupled by heat flux and stage temperature. The front and back heat flux is calculated from the previous stage, thus the equations of (S25) and (S26) can be also applied.

### Cogeneration of Electricity and Water Under Lab Conditions

To experimentally validate the performance of the proposed bio-inspired SSCD system, four configurations were fabricated and comparatively analyzed under theoretical guidance (FIGS. 14I to 14K, and FIG. 14M to 14O). They include: (1) a standalone CdTe PV cell; (2) a 5-stage ECD device; (3) an SSCD device with a 5-stage PV module and a 4-stage TA module; (4) an SSCD device with a 10-stage PV module and a 10-stage TA module.

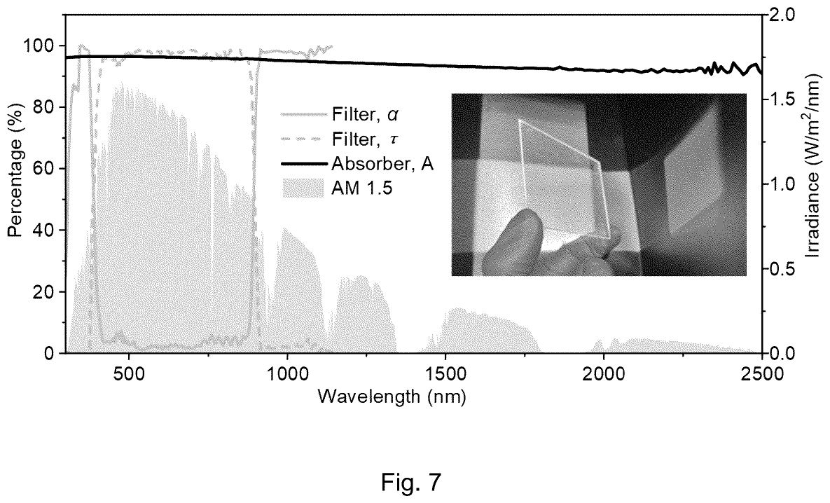

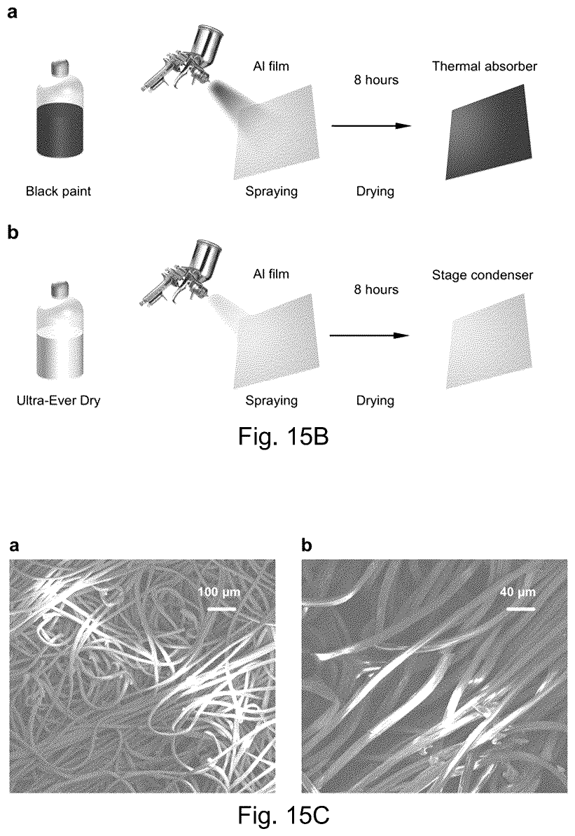

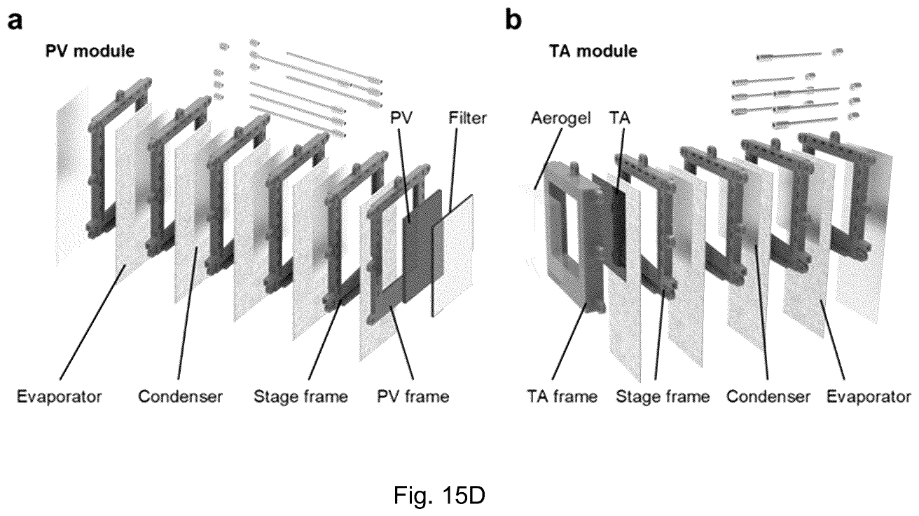

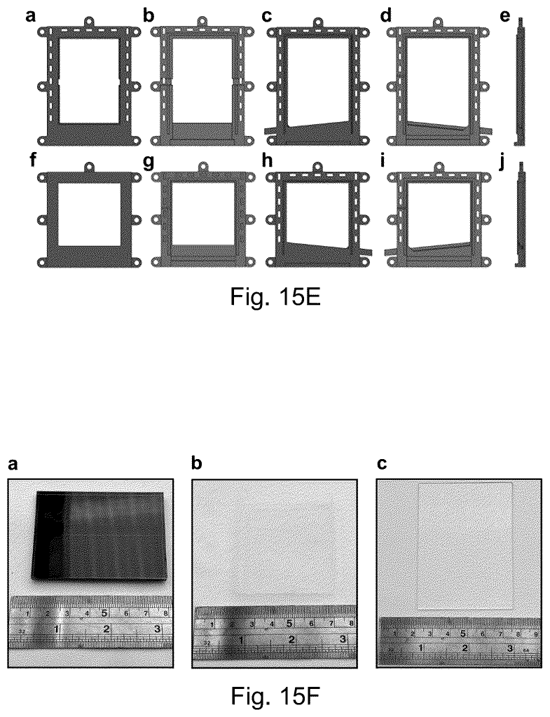

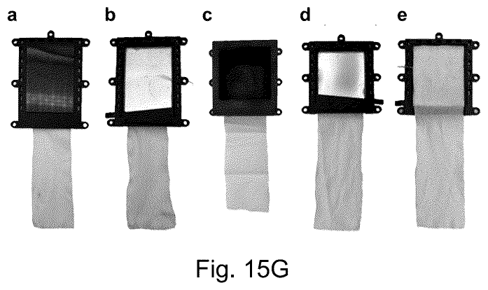

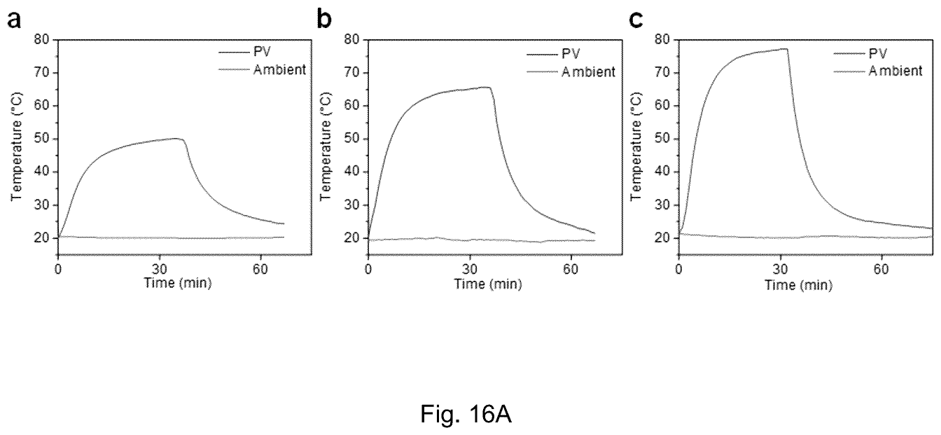

The optical spectral performance of the filter was rigorously characterized, demonstrating 95.9% transmittance across 385-863 nm (above the bandgap of CdTe) and 78.3% reflectance in the 863-2500 nm, as shown in FIG. 7. This dual functionality enables efficient transmission of PV-active photons while reflecting below-bandgap energy to the thermal absorber. The absorber surface, coated with optimized black paint, achieved 95.5% broadband absorptance (94.3% in 863-2500 nm), ensuring effective capture of redirected NIR radiation. Hydrophobic condenser surfaces minimized thermal resistance from liquid films while promoting droplet runoff (FIG. 15A), with detailed fabrication processes documented in FIG. 15B. After spraying, all films were kept at room temperature for 8 hours. Device construction employed high-sorption capillary wicks exhibiting strong fluid transport capacity (FIG. 15C). These scanning electron microscope (SEM) images reveal that the capillary wick exhibits a quasi-directional structure at the microscopic level, with abundant tubular fibers providing the basis for its strong capillary force.

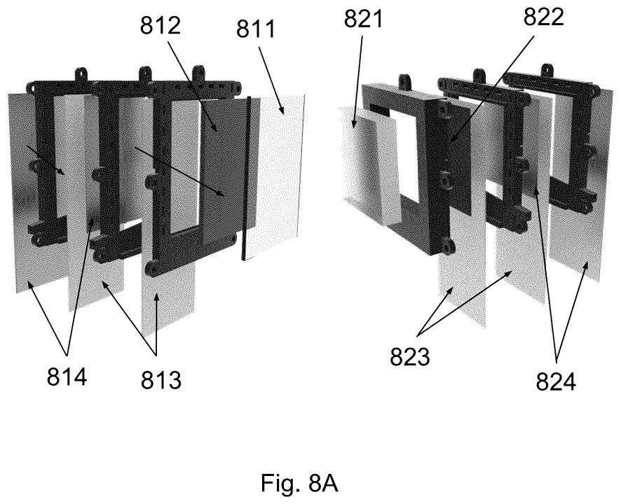

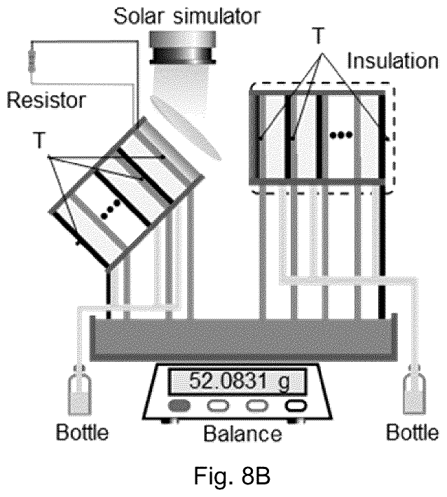

Considering the airgap distance discussed in the previous section and the precision of device dimensions, the dimension of 5 mm was selected. FIG. 8A illustrates core components of an embodiments of the system, including the filter 811; the PV panel 812, the evaporator 813, and the condenser 814 of the PV model; and the aerogel 821, the thermal absorber 822, the evaporator 823 and the condenser 824 of the TA module. FIGS. 15D to 15G provide detailed structures of the 5,4S-SSCD configuration. Referring to FIG. 15D, the PV frame and TA frame are designed to securely hold their respective components. The stage frames within the module are identical and adjustable to control the distance of the airgaps. The condenser is fixed inside the stage frame using glue, while the evaporator is attached to the condenser with thermally conductive double-sided adhesive. The device is assembled using bolts and nuts.

The frames as shown in FIG. 15E comprise grooves to collect condensate, and to allow water to flow out of the frame by gravity, the grooves are inclined at an angle of 5.7°. To prevent vapor leakage, each frame is designed with an interlocking structure featuring protrusions and recesses at the rear to seal the air gap.

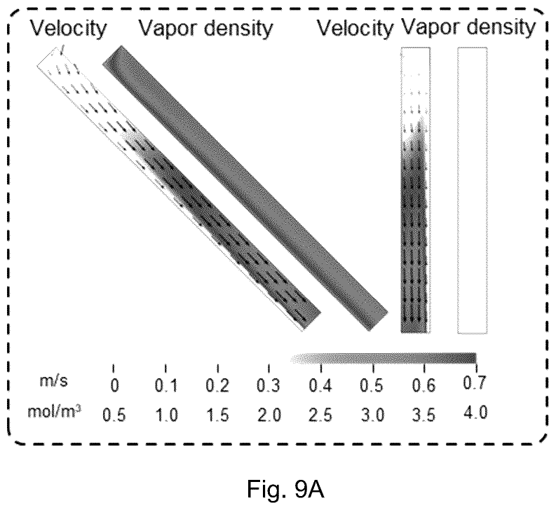

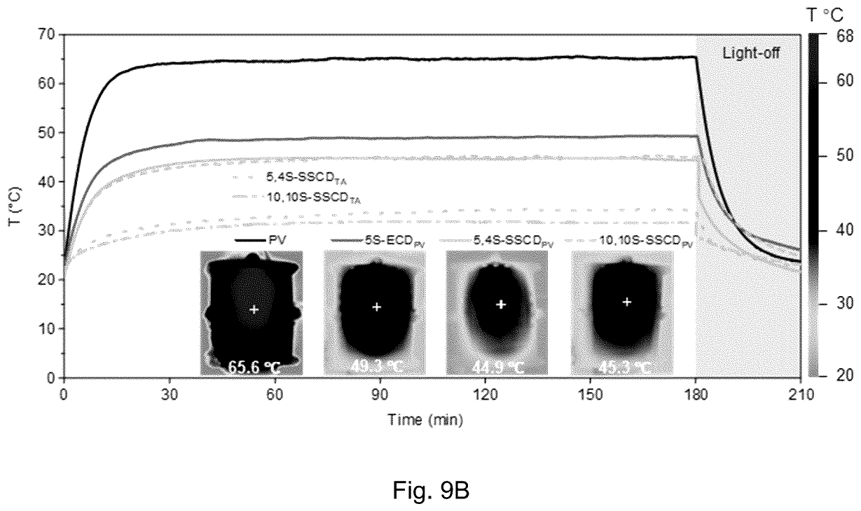

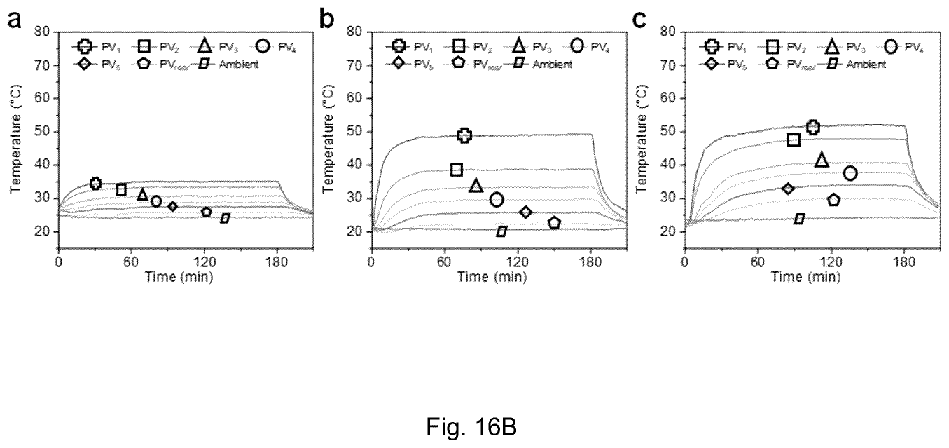

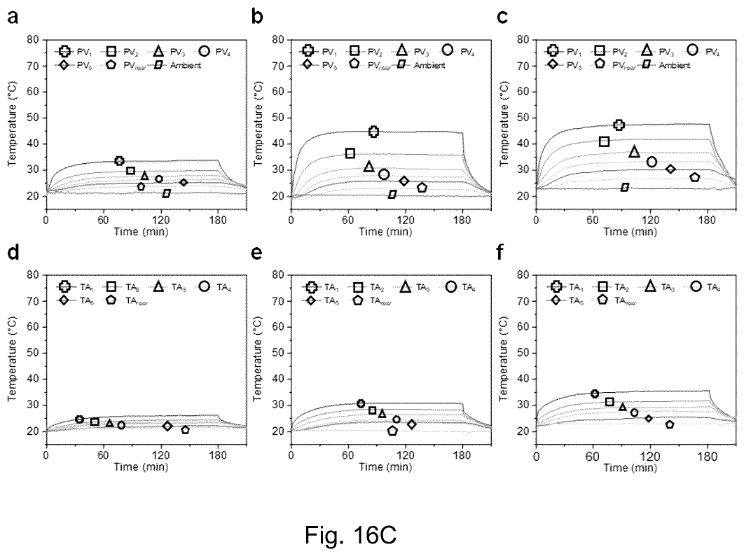

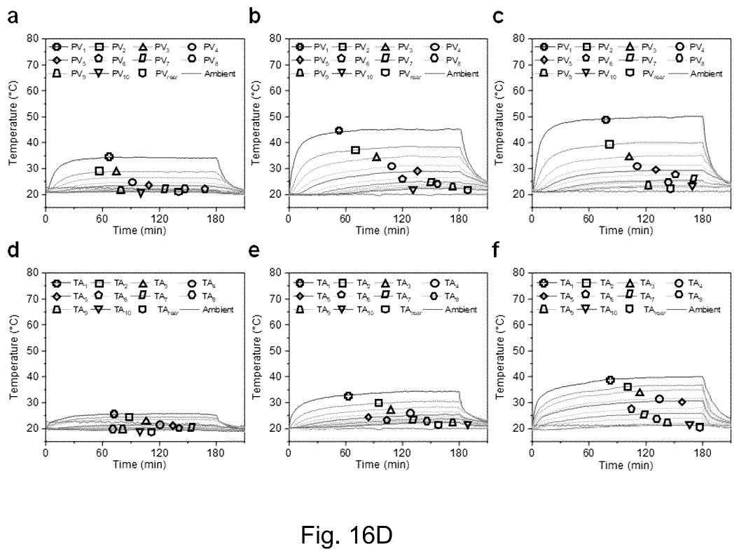

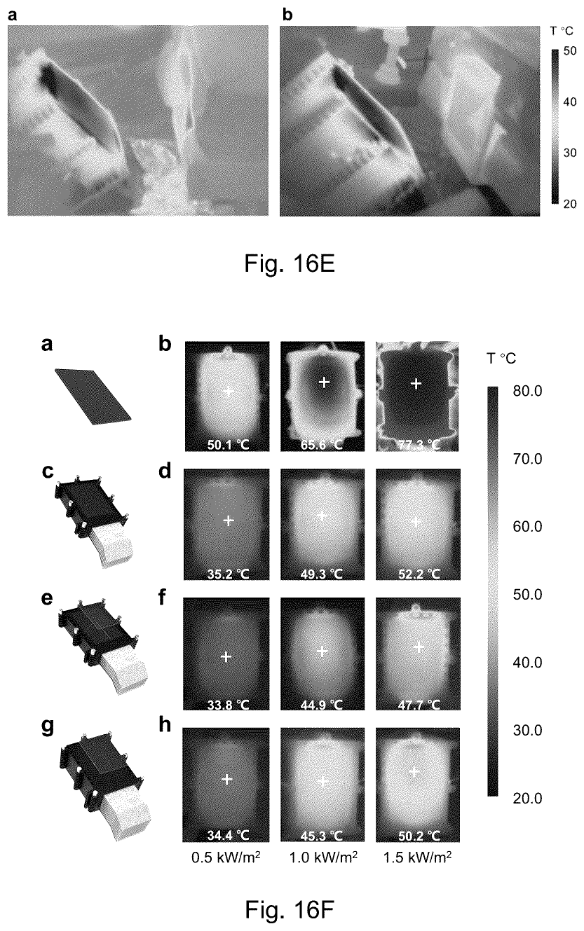

The laboratory measurement setup is illustrated in FIG. 8B. A solar simulator generated AM 1.5G illumination to mimic one-sun conditions. Thermocouples were employed to record temperature profiles across all stages, while a high-precision electronic balance continuously monitored water mass changes in the seawater reservoir. Freshwater output from each stage was collected in pre-weighed bottles for gravimetric analysis. FIG. 9B presents the temperature evolution of the standalone PV, ECD, 5,4S-SSCD, and 10,10S-SSCD devices over 3 hours under standardized conditions (one-sun irradiance, 21 °C ambient). The standalone PV exhibited a peak temperature of 65.6 °C, whereas the 5-stage PV module in the 5,4S-SSCD configuration stabilized at 44.9 °C, indicating a substantial temperature reduction of 20.7 °C attributable to the spectral-splitting design. Notably, increasing the PV module stages from 5 to 10 introduced incremental thermal resistance, raising the maximum PV temperature marginally from 44.9 °C to 45.3 °C. Concurrently, the thermal absorbers in the 5,4S-SSCD and 10,10S-SSCD attained maximum temperatures of 31.9 °C and 34.3 °C, respectively. These values remain markedly lower than corresponding PV temperatures due to the reduced energy flux of reflected below-bandgap photons compared to transmitted above-bandgap radiation. Enhanced insulation in the 10-stage TA module contributed to the slightly elevated thermal absorber temperature relative to the 4-stage configuration. FIGS. 16A to 16D provide comprehensive stage-specific temperature data under varying irradiance intensities (0.5, 1.0, and 1.5 kW/m2). Infrared thermography further validated thermal performance: inset IR images in FIG. 9B visualize surface temperature distributions of PV cells across devices, while FIG. 16E displays thermal profiles of the 5,4S-SSCD and 10,10S-SSCD devices. Quantitative surface temperature analyses under distinct operational modes are systematically catalogued in FIG. 16F.

Numerical simulations illustrate spatial distributions of vapor concentration and velocity profiles within the airgap of the SSCD device, as visualized in FIG. 9A. Comparative analysis shows that reduced airgap temperature in the TA module relative to the PV counterpart results in proportionally diminished vapor concentrations.

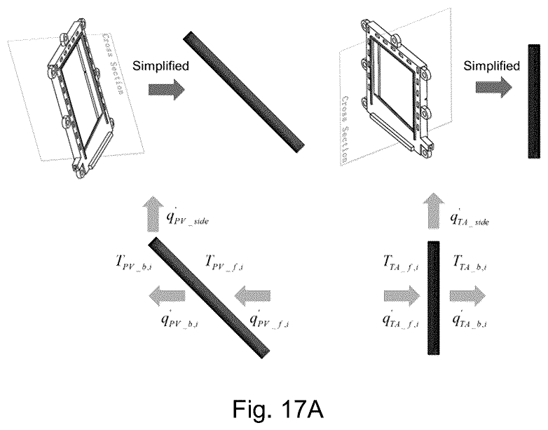

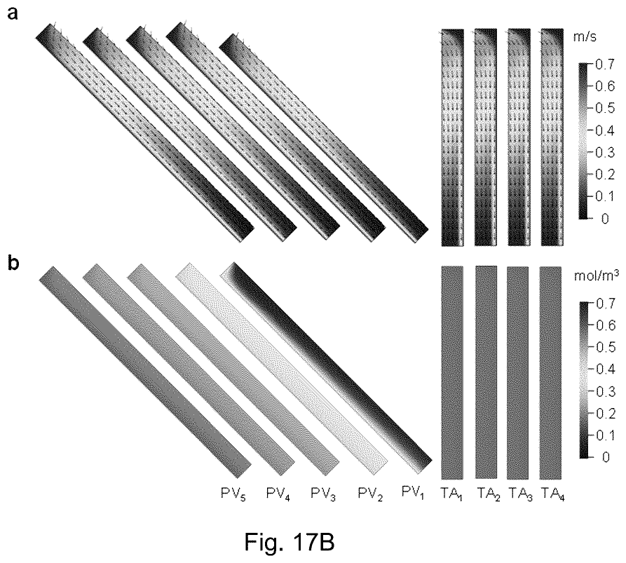

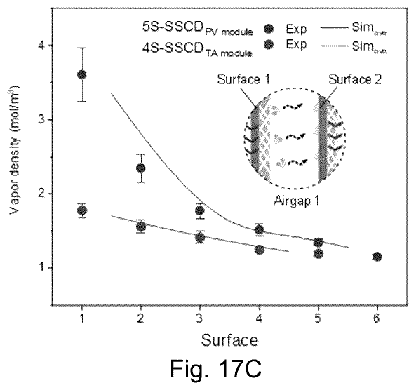

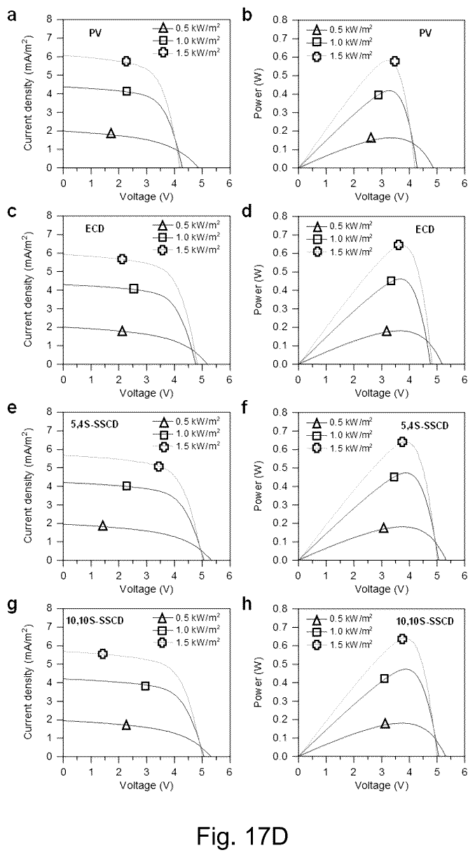

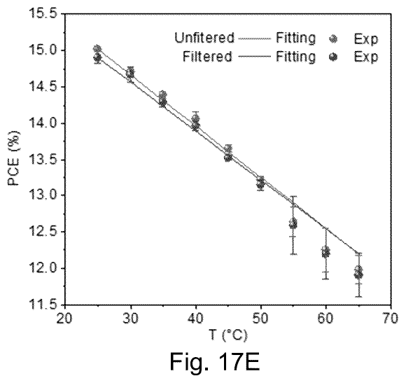

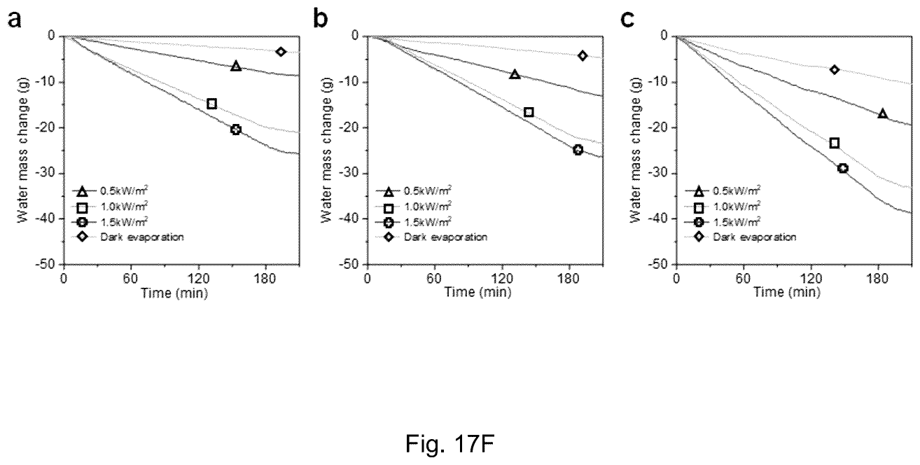

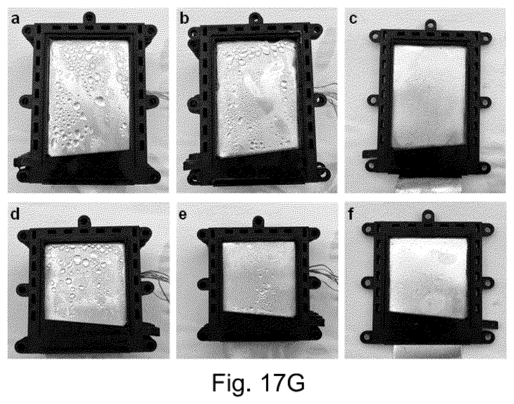

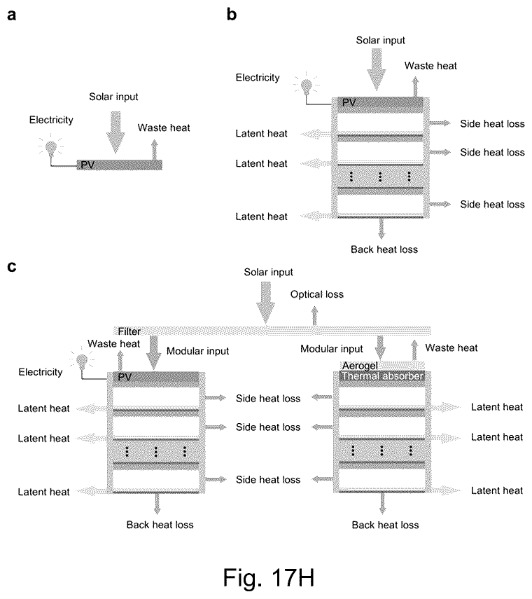

Vapor concentration gradients arise primarily from variations in mass transfer intensity, exhibiting reduced values in stagnant flow regions. Spatiotemporal vapor distribution patterns confirm natural convection as the dominant mass transfer mechanism, demonstrating negligible dependence on airgap orientation or thermal gradients. FIGS. 17A to 17C further demonstrate an inverse correlation between vapor concentration and both stage number increment and temperature reduction across the air gap.

In the PV module, the first three stages exhibit higher vapor concentrations, dominated by freshwater condensation. In contrast, all airgaps in the TA module have lower vapor concentrations.

In contrast, vapor velocity profiles remain temperature-independent, governed principally by the gravitational acceleration that induces peak velocity magnitudes at the airgap base.

FIG. 17B demonstrates the heat and mass transfer within the airgaps of the 5,4S-SSCD device. Inside the air gaps, natural convection is driven by gravity, with air freely exiting through the lower outlet. The velocity magnitude is solely dependent on the vertical height. Consequently, as illustrated in part (a) of FIG. 17B, the gas flows in from the front end and exits at the lower end, with the velocity magnitude being inversely proportional to the height. Additionally, a stagnant velocity region appears at the upper rear, which could be optimized in future studies. The vapor concentration is proportional to the temperatures of the front and back surfaces, as shown in part (b) of FIG. 17B. In the PV module, the first three stages exhibit higher vapor concentrations, dominated by freshwater condensation. In contrast, all airgaps in the TA module have lower vapor concentrations. Both numerical and experimental results indicate that in the initial stages, the vapor difference is more pronounced, leading to a higher condensation of fresh water. After the fourth stage, the vapor difference becomes less significant, and the efficiency of water production gradually decreases.

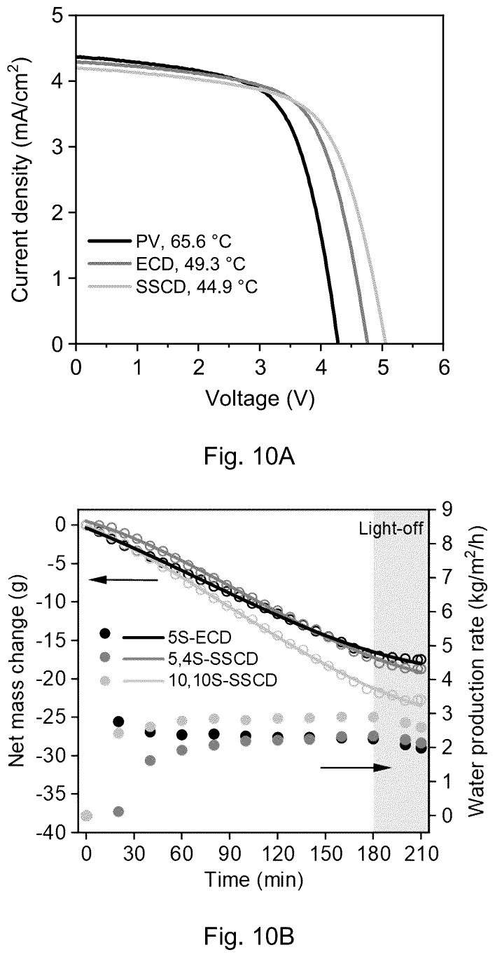

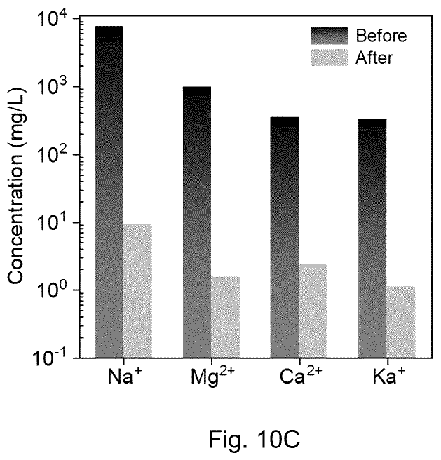

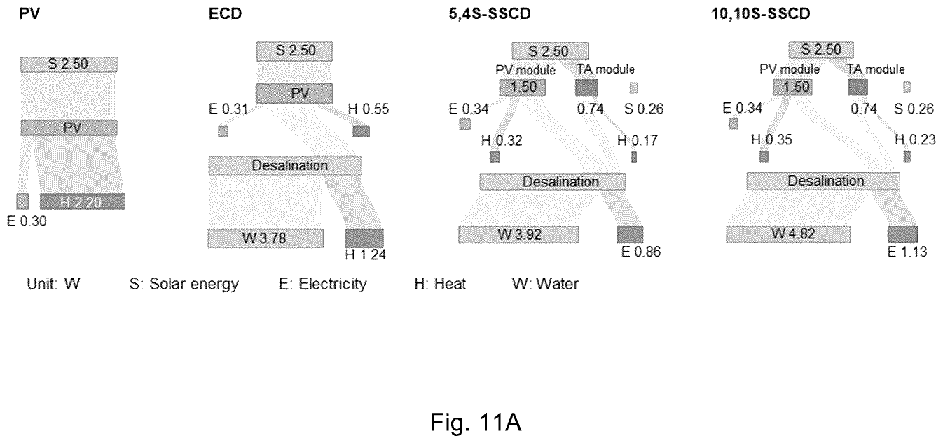

Under one-sun illumination, the electrical characteristics of the PV, ECD, and SSCD devices are presented in FIGS. 10A, 17D, and 18A. The J-V curves reveal maximum PCEs are 11.98% for the PV, 12.21% for the ECD, and 13.52% for the SSCD. Power output is relatively insensitive to minor temperature changes, resulting in identical maximum PCE for both the 5,4S-SSCD and 10,10S-SSCD. The ECD and SSCD exhibit enhancements of 1.9% and 12.9% compared to the standalone PV, respectively, due to their lower operating temperatures. The temperature coefficients of the current CdTe cell were calculated for both the pure cell and filtered cell (FIG. 17E).

As observed in FIG. 17E, the current density experiences a slight decrease following the implementation of the spectral-splitting filter. This reduction is attributed to the loss of light intensity resulting from the imperfect transmittance of the filter. For unfiltered PV cell, the correlation is η_{T,un}=15.02×[1−0.0047×(T−25)], where T is in °C. And similarly, for filtered PV, the utilization of filters results in partial energy loss of incident light, consequently causing a slight decrease in PCEs. Nevertheless, the fundamental trend remains similar throughout filtered correlation, which is given as η_{T,f}=14.90×[1−0.0045×(T−25)].

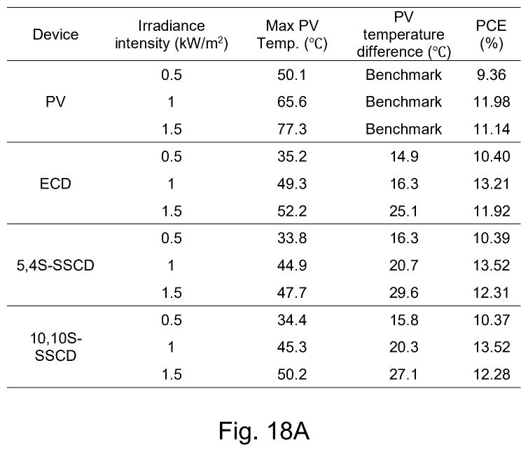

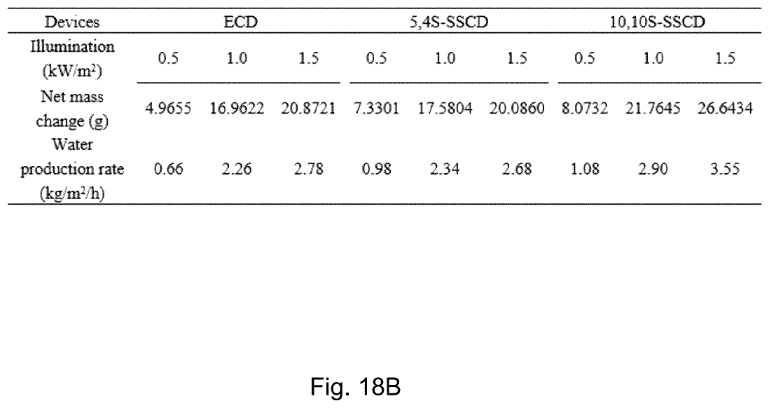

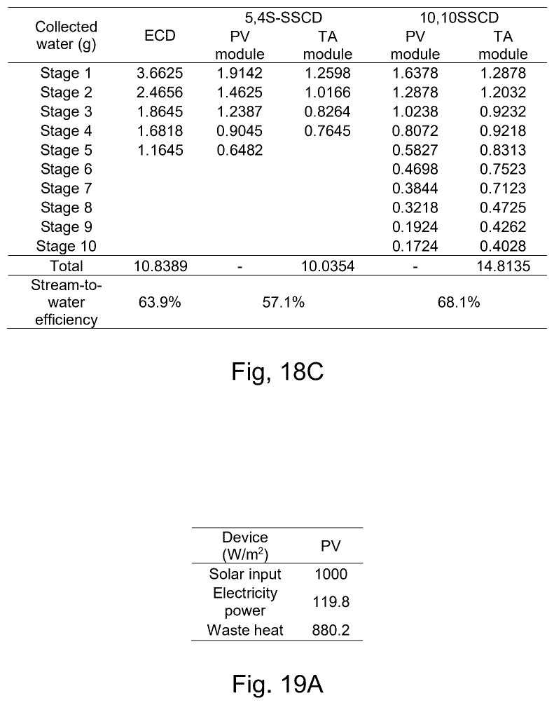

Quantitative evaluation of water production rates in the ECD and SSCD systems was conducted through continuous gravimetric monitoring of reservoir mass variations under standardized conditions, with results presented in FIG. 10B and FIG. 17F. Following three hours of continuous illumination, gravimetric measurements recorded total net mass reductions of 17.0 g, 17.6 g, and 21.8 g for the 5S-ECD, 5,4S-SSCD, and 10,10S-SSCD configurations, respectively (FIGS. 17G and 18B). On the condenser surface, droplets grow, merge, and slide off as condensation increases, leaving visible trails, as shown in parts (a), (b), and (d) of FIG. 17G. As vapor concentration is low and duration is short, condensate forms beads that do not flow out of the channel, as depicted in parts (c) and f of FIG. 17G. To measure the condensate, we wiped the surface with paper tissue and weighed the mass change before and after.

These values translate to freshwater production rates of 2.26 kg/m2/h, 2.34 kg/m2/h, and 2.90 kg/m2/h, accompanied by thermal efficiencies of 150.3%, 155.6%, and 192.9%. The observed thermal efficiency of 192.9% marginally exceeds the numerically predicted value of 186.5%, a discrepancy attributed to the lower PCE of the implemented CdTe PV cells compared to reported-record data. This deviation indicates enhanced thermal energy utilization due to reduced electrical conversion efficiency. Further analysis quantified the collected freshwater yields as 10.8 g, 10.0 g, and 14.8 g for the 5S-ECD, 5,4S-SSCD, and 10,10S-SSCD systems, respectively, translating to stream-to-vapor efficiencies of 63.9%, 57.1%, and 68.1% (FIG. 18C). Even after excluding negligible uncollected liquid water, significant vapor dissipation persists during operation, indicating that freshwater production rates are also limited by the condensation rate. Ion chromatographic analysis of desalinated output (FIG. 10C) revealed drastic reductions in Ca²⁺, Na⁺, K⁺, and Mg²⁺ concentrations, all complying with World Health Organization (WHO) guidelines for drinking water. Initial seawater salinity of 2.5 wt % was effectively reduced to an average post-treatment salinity of 0.4 wt %, demonstrating the system's robust desalination capability.

### Performance Evaluation

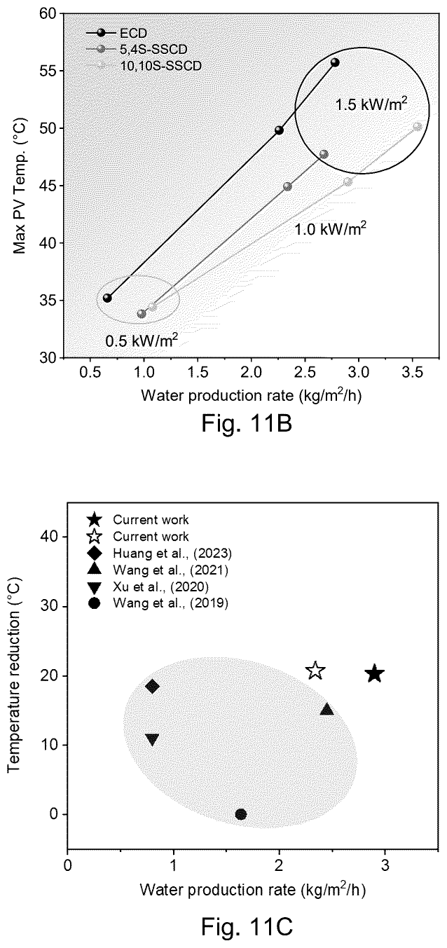

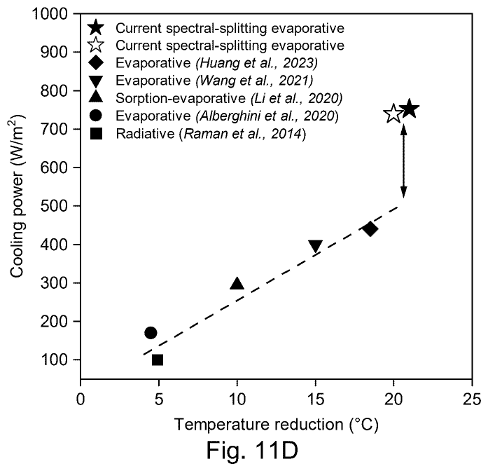

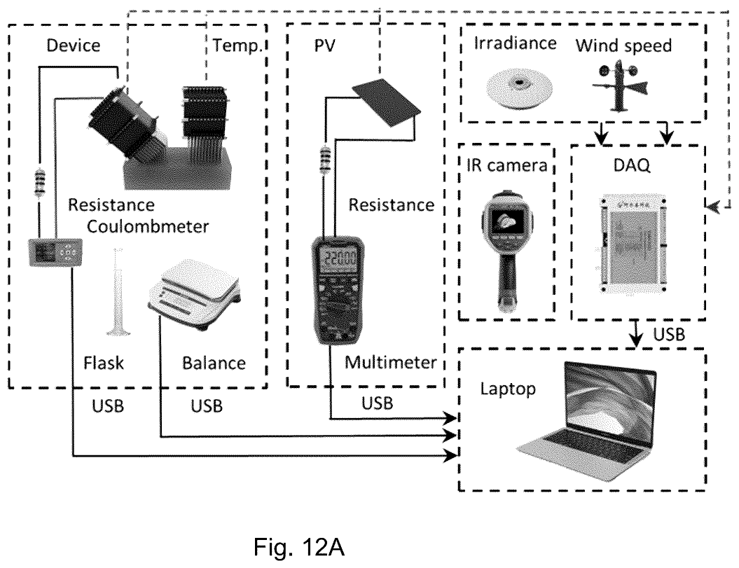

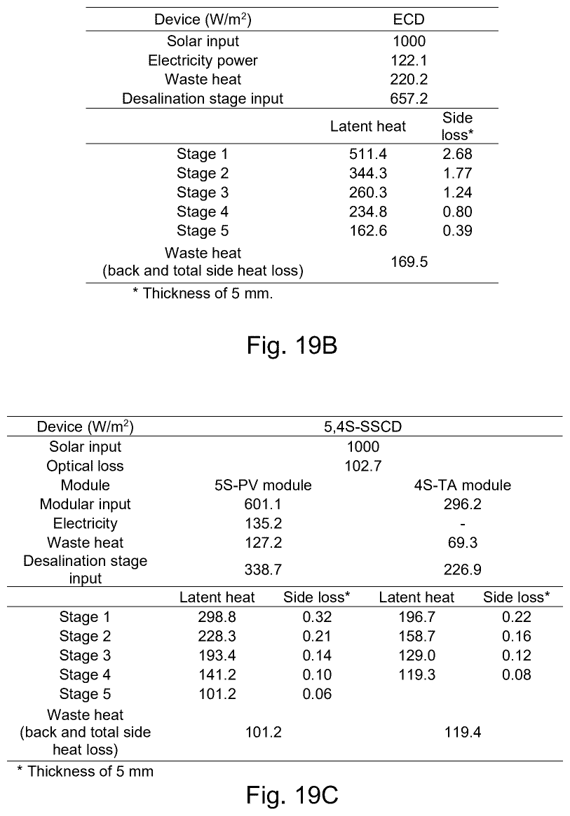

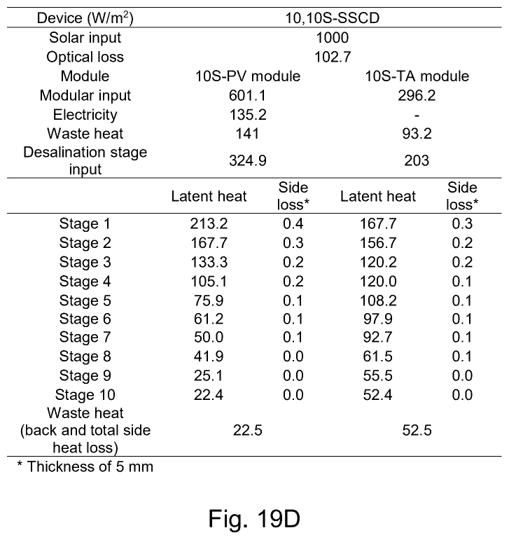

To quantitatively evaluate system performance, energy conversion metrics of the PV, ECD, 5,4S-SSCD, and 10,10S-SSCD configurations were systematically compared. Real-time energy flow analysis under one-sun illumination (FIG. 11A, 17H, and FIGS. 19A to 19D) revealed distinct operational characteristics. For a solar input of 2.50 W, the standalone PV configuration dissipated 2.20 W as thermal losses, whereas the ECD system repurposed 3.78 W of thermal energy for freshwater production. SSCD architecture achieved a dual benefit: thermal dissipation decreased to 0.32 W, electrical output increased to 0.34 W, and desalination energy utilization reached 3.92 W for the 5,4S-SSCD and 4.82 W for the 10,10S-SSCD. This thermal decoupling strategy achieved a cooling power density of 752 W/m2 by suppressing dissipated heat from 2.20 W to 0.32 W, positioning it as a promising solution for passive PV thermal management.

Comparative evaluations under irradiance levels of 0.5, 1.0, and 1.5 kW/m2 further highlighted system adaptability (FIG. 11B). The ECD system consistently exhibited PV temperatures exceeding those of both SSCD configurations. Spectral splitting induced progressively greater temperature reductions as irradiance intensified. At 0.5 kW/m2, the 5,4S-SSCD achieved a freshwater yield of 0.98 kg/m2/h, outperforming the ECD's 0.66 kg/m2/h. However, under 1.5 kW/m2 irradiance, the ECD's elevated first-stage temperature enhanced vapor concentration, yielding 2.78 kg/m2/h compared to 2.68 kg/m2/h of the 5,4S-SSCD. Crucially, the 10,10S-SSCD maintained superior performance across all conditions, with PV temperatures stabilized below 34.4 °C, 45.3 °C, and 50.1 °C while water production rates exceeded 1.08 kg/m2/h, 2.90 kg/m2/h, and 3.55 kg/m2/h, validating the efficacy of multistage thermal decoupling.

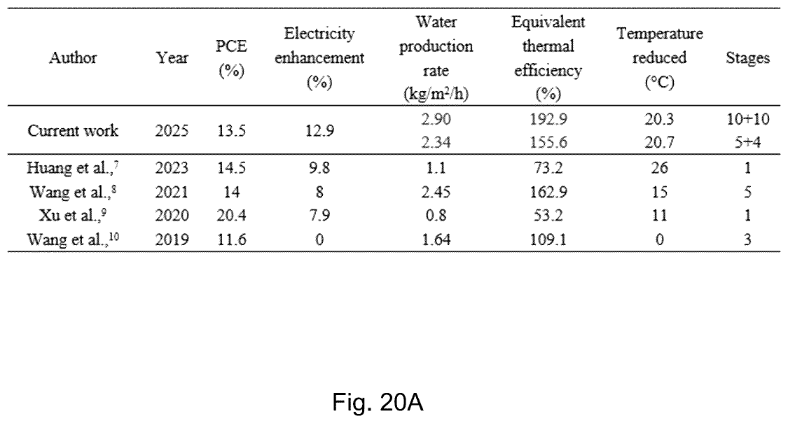

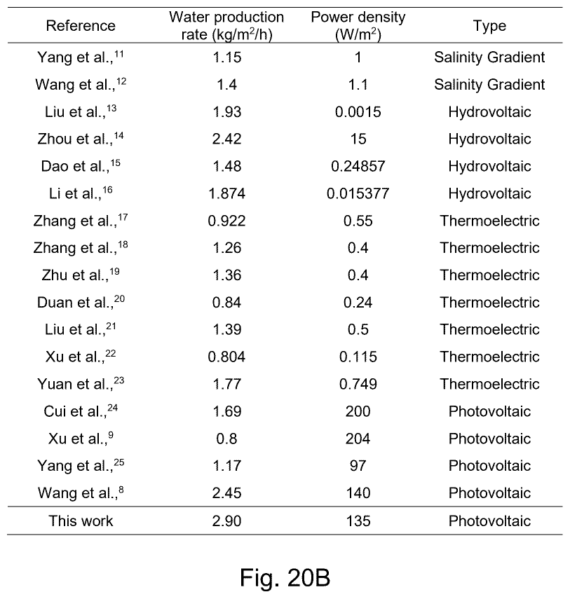

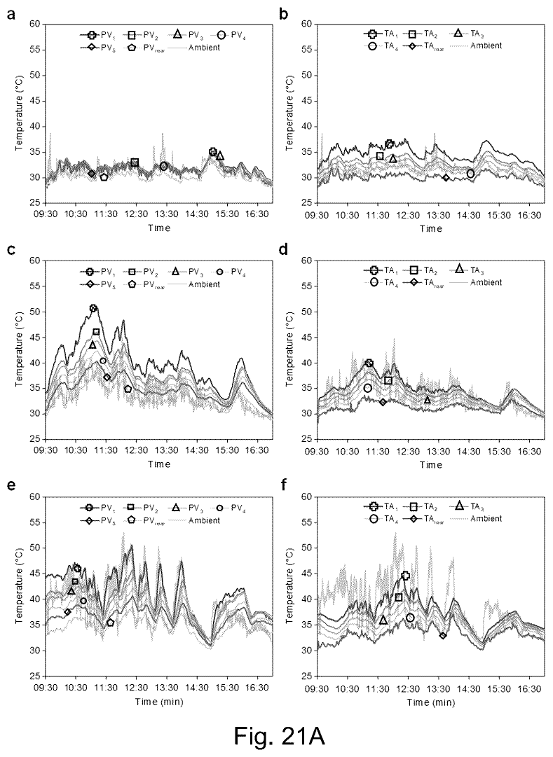

FIG. 11C offers a comparative analysis of the current biomimetic device against existing research in passive PV cooling and cogeneration of electricity and water (FIG. 20A). All selected data are derived from laboratory experiments conducted under a standardized radiation energy of 1.0 kW/m2. A representative electricity-water cogenerator employs an aluminum nitride thermal conductive plate to transfer PV waste heat into a three-stage desalination unit, initially achieving a freshwater production rate of 1.64 kg/m2/h28. An infrared-transparent PV device with a waterproof thermal interlayer further enhanced temperature reduction (ΔT=11 °C) alongside freshwater yield (0.8 kg/m2/h)29. Alternatively, a five-stage design utilizing stainless steel as the thermal conductive layer achieved superior temperature reduction (ΔT=15 °C) and a record water production rate (2.45 kg/m2/h) while enabling salt crystal recovery for zero liquid discharge27. To improve brine transport efficiency, a cogenerator with fiber-supported hydrogel thermal layer was proposed, delivering enhanced cooling (ΔT=18.5 °C) but suboptimal water yield (0.8 kg/m2/h) due to its single-stage architecture40. The SSCD system overcomes these trade-offs through a thermally decoupled design, simultaneously optimizing cooling and freshwater production. It outperforms all benchmarks by achieving a 20.7 °C. PV temperature reduction, a 12.9% enhancement in power conversion efficiency, and a record-breaking freshwater yield of 2.90 kg/m2/h. With a photovoltaic efficiency of 13.5% and thermal efficiency of 192.9%, the system attains a total energy efficiency of 206.4%, establishing a new paradigm for energy-water cogeneration. Other types of solar-driven electricity-water cogeneration technologies are also compared with the current work in terms of power density and water production rate (FIG. 20B).

The current bio-inspired SSCD is also compared with other state-of-the-art passive cooling methods. The cooling capacity of SSCD reaches 752 W/m2, significantly outperforming radiative cooling methods (100 W/m2), atmospheric-water sorption-evaporative cooling (295 W/m2), and other evaporative cooling solutions (170-440 W/m2), as shown in FIG. 11D. Previous studies have demonstrated a linear relationship that nearly every 115 W/m2 cooling capacity decreases 5 °C in temperature. Yet, a notable leap from this trend is observed in the current work, likely due to the thermal decoupling achieved through spectral filtering. This finding suggests that the current work may offer novel mechanistic insights for PV performance enhancement.

The proposed device is a scalable, repeatable, and sustainable technology due to the following advantages:
The system can provide a significant cooling effect, enhancing the current photovoltaic efficiency without the need for additional complex cooling devices.
The system is applicable for cooling various types of PV panels, with no restrictions on PV materials, size, or quantity, offering flexibility and adaptability.
The system is capable of providing fresh water that meets drinking water standards, sufficient for domestic and agricultural use.
The water source for freshwater production can be seawater, domestic wastewater, rainwater, river water, or groundwater. This characteristic enables the system to address water scarcity issues caused by various factors.
The materials used in the system are common and cost-effective, allowing for substitutions based on cost or performance requirements. These features make the device suitable for most regions.

### Field Performance of SSCD

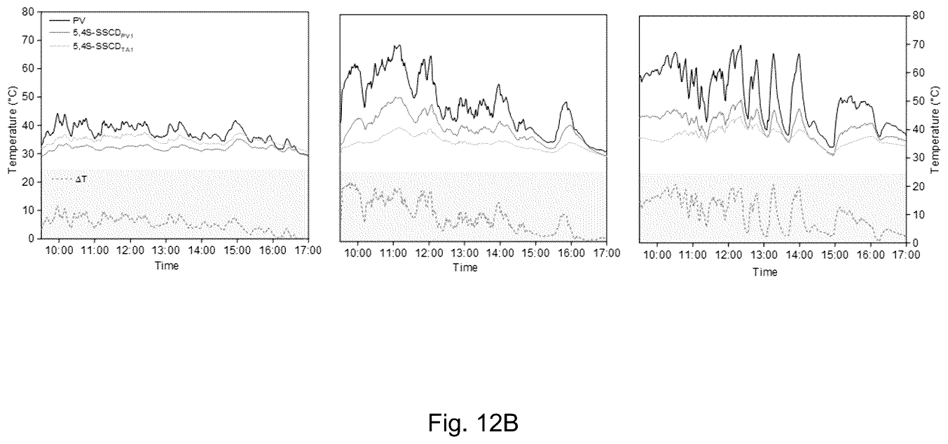

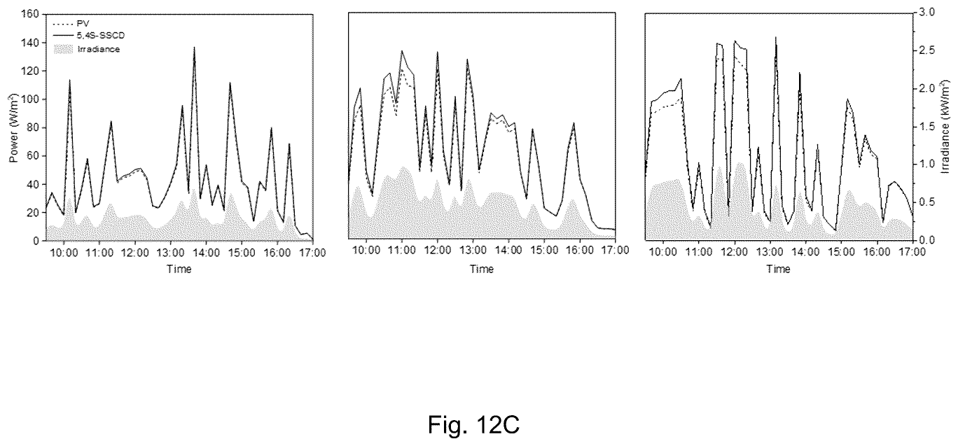

To demonstrate the performance of this system, a field experiment is conducted. FIG. 12A shows a schematic diagram of the test setup. Real-time wind speed and solar radiation are measured using a radiometer and an anemometer, respectively. Temperatures are measured with K-type thermocouples, and data is transmitted to a laptop via a data acquisition system. Both the sole PV cell and an embodiment of a system of the present invention are connected in series with a resistor, and real-time current is measured using a multi-meter and a coulombmeter, with data sent to the laptop. The water production rate of the device is calculated based on the mass changes of the reservoir, which are measured in real-time by an electronic balance. Surface temperatures of the sole PV cell and a system of the present invention are recorded using an infrared (IR) camera. The produced freshwater is collected via tubes into a flask.

Solar irradiance and wind speed were monitored in real-time using a calibrated radiometer and cup anemometer, respectively. Temperature profiles were recorded through K-type thermocouples, with transmitted data logged via a dedicated acquisition module. Standalone PV and 5,4S-SSCD devices were electrically loaded with 25Ω and 30Ω resistors, selected based on maximum power point tracking under standardized laboratory conditions, while real-time current measurements were obtained simultaneously through a multimeter and coulomb meter. Freshwater production rates were calculated from continuous gravimetric monitoring of reservoir mass changes using a high-precision electronic balance, with surface temperature distributions captured periodically by an infrared thermal camera.

The field deployment positioned both PV cells at 45° south-facing tilts to maximize solar exposure. Meteorological conditions during the three-day trial progressed from fully overcast skies (Day 1:2.29 kWh/m2) through partially cloudy intervals (Day 2:3.41 kWh/m2) to intermittent cloud cover (Day 3:3.67 kWh/m2), systematically evaluating performance under varying insolation regimes.

The outdoor experimental results show that an embodiment of the system of the present invention can effectively reduce the operating temperature of the PV cell, thereby increasing the power generation while also producing freshwater. On the first day, it was cloudy with strong winds; on the second and third days, it was slightly windy and hot.

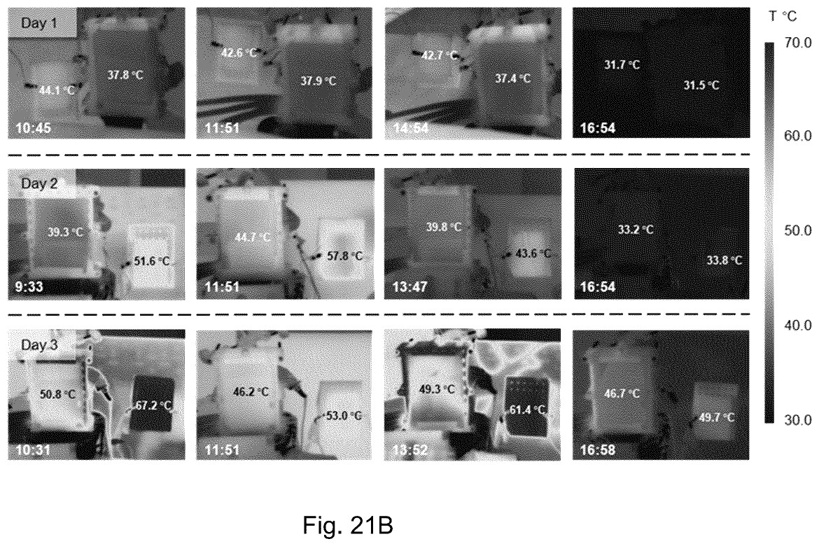

The PV temperatures of the standalone PV and 5,4S-SSCD are shown in FIG. 12B, and the stage temperatures are shown in FIG. 21A. Temperature profiles revealed that the standalone PV averaged 43 °C on Day 1, while the 5,4S-SSCD maintained 37 °C, peaking at a 12 °C differential. Under larger irradiance on Day 2 and Day 3, the standalone PV exceeded 70 °C, whereas the SSCD stabilized at 50 °C, achieving temperature differentials of 20.9 °C and 20.6 °C, respectively. Infrared thermography (FIG. 21B) corroborated the effective cooling of SSCD.

To quantify spatial-temporal thermal profiles of the standalone PV and 5,4S-SSCD, high-resolution infrared thermography was conducted at multiple diurnal intervals across these field trials. Comparative analysis revealed the following:
Day 1: Observed surface temperature differentials ranged 0.2-6.3 °C, marginally lower than thermocouple-recorded values due to convective heat dissipation at the PV surface modulated by wind-induced airflow (0.3-12 m/s).
Day 2: Morning and early afternoon exhibited significant thermal gradients with average differentials of 12.3 °C and 13.1 °C respectively, contrasting sharply with afternoon/evening measurements of 3.8 °C and 0.6 °C. This diurnal variation demonstrates strong correlation between surface thermal dynamics and incident radiation intensity, while highlighting convective interference.
Day 3: Maximum morning temperature differential reached 16.4 °C, coinciding with peak irradiance of 1,020 W/m² under intermittent cloud cover.

Notably, when 5,4S-SSCD surface temperatures approached 50 °C, the evaporative cooling mechanism became thermally dominant. The rear-mounted evaporator, employing capillary-driven fluid transport from the brine reservoir, established a vertical thermal gradient, maintaining base temperatures 7-12 °C below upper surface levels through latent heat absorption.

The output power of PV demonstrates a significant correlation with ambient temperature and solar irradiance, as illustrated in FIG. 12C. During initial field testing under overcast conditions, maximum irradiance intensity remained below 0.8 kW/m2, while subsequent days exhibited peak irradiance exceeding 1 kW/m2. Under low-irradiance conditions with minimal temperature difference, both standalone PV and 5,4S-SSCD configurations showed comparable power outputs (ΔP<8 W/m2). However, during high-irradiance periods on Days 2 and 3, the standalone PV experienced power reduction due to efficiency losses from temperature-induced PCE degradation. The 5,4S-SSCD device effectively mitigated this performance decline through passive thermal management, maintaining stable operation with measured power output advancement comparing standalone PV, from 129.8 W/m2 to 144.2 W/m2 (Day 2) and 136.0 W/m2 to 149.7 W/m2 (Day 3), corresponding to relative enhancements of 11.1% and 7.9%, respectively.

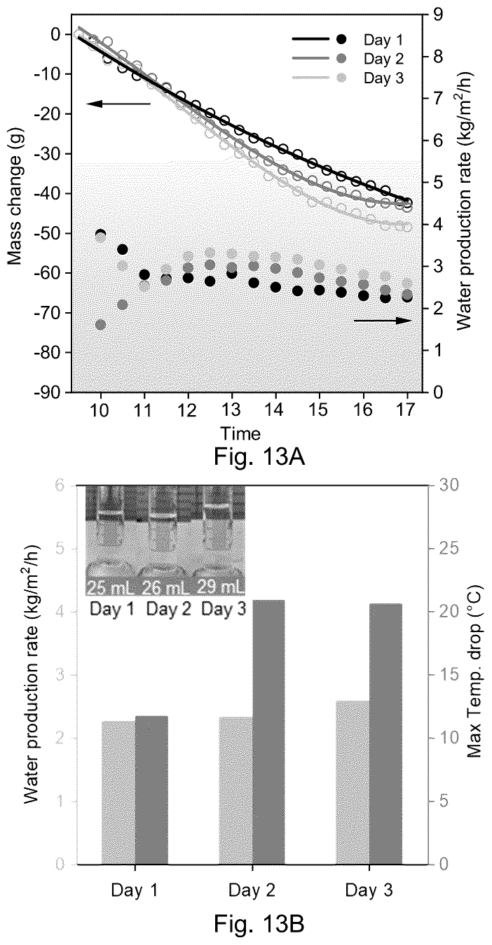

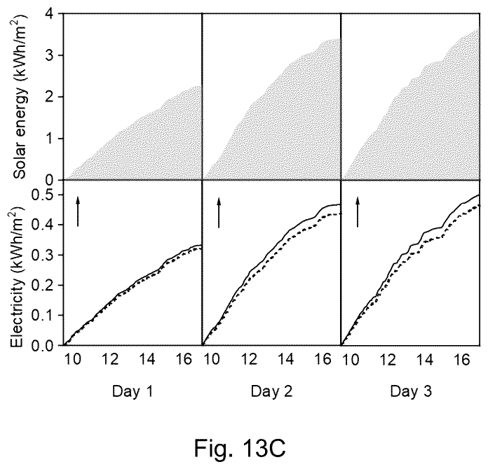

Freshwater collection remained robust across all conditions (FIG. 13A), with rates of 2.26 kg/m2/h (Day 1), 2.32 kg/m2/h (Day 2), and 2.58 kg/m2/h (Day 3), as demonstrated in FIG. 13B. Volumetric measurements using a graduated cylinder, as shown in the inset photo of FIG. 13B, quantified daily freshwater yields as 25 mL, 26 mL, and 29 mL over these trials, respectively. The capillary wick demonstrated no clogging or salt crystallization during experiments, likely because of nocturnal natural water convection within the wick in the absence of evaporation, which facilitates ion concentration equilibrium restoration. The maximum temperature reductions of SSCD are 11.7 °C, 20.9 °C, and 20.3 °C compared to the standalone PV for three days.

Additionally, the accumulated solar energy and the generated electricity were calculated, as shown in FIG. 13C. With daily solar energy inputs of 2.29 kWh/m2, 3.41 kWh/m2, and 3.67 kWh/m2, the SSCD achieved energy improvements of 2.90%, 6.52%, and 7.31%, respectively, compared to the standalone PV. This demonstrates that the bio-inspired SSCD can enhance electricity generation while producing sufficient freshwater under bright and hot weather conditions, showing great potential for addressing the energy-water nexus in suitable regions.

### DISCUSSION

Embodiments of the present invention provides a bio-inspired SSCD methodology to address the energy-water nexus through advanced photovoltaic thermal management. This approach enables concurrent electricity generation and freshwater production via full-spectrum solar utilization. The SSCD architecture achieves thermal decoupling between photovoltaic and desalination modules, significantly reducing operating temperatures while surpassing previous thermally coupled designs in freshwater yield. By implementing enthalpy recovery across multistage processes, the system attains an exceptional overall efficiency of 206.4%, demonstrating the practical potential for household electricity and water supply applications. Under standardized one-sun illumination (AM 1.5G), the SSCD reduces PV operating temperatures by 20.7 °C, corresponding to a 12.9% enhancement in power conversion efficiency, while maintaining a freshwater production rate of 2.90 kg/m2/h. The integrated spectral splitting-evaporative cooling mechanism delivers a cooling capacity of 752 W/m2, establishing a new benchmark for passive PV thermal management. Field validation under harsh environmental conditions confirmed reliable clean water production and consistent efficiency improvements compared to standalone PV systems, with measured electricity output enhancements up to 7.31%. This passive SSCD modification strategy and structural compatibility with conventional PV panels facilitate seamless integration without complex retrofitting requirements.

In an embodiment, the SSCD technology of the present invention holds significant potential for large-scale deployment in photovoltaic installations, particularly in regions utilizing non-potable water sources such as wastewater or river water. This system could empower off-grid communities to achieve energy-water self-sufficiency through environmentally sustainable cogeneration. Further performance enhancements may be realized through integration with passive optical concentrators like Fresnel lenses, which could amplify both electrical output and freshwater production without requiring additional energy inputs. As a biomimetic solution aligning spectral management with thermal regulation, the SSCD framework provides a viable pathway toward addressing global energy-water challenges, potentially catalyzing interdisciplinary research efforts in sustainable resource harvesting.

### Methods

### Materials

The PV cells were procured from ASP Co., Ltd. Seawater samples were collected from Repulse Bay, Hong Kong. Sodium chloride of 99.8% purity and capillary wicks were procured from Aladdin Co., Ltd. and Licheng Biotechnology Co., Ltd., respectively. Device frames were 3D-printed using nylon, while optical components included a broadband filter from Yongxing Sensing Co., Ltd. and transparent aerogel insulation from Aerogel Technologies, LLC.

### Structures of the Components

The photovoltaic module integrated a 7×5 cm² CdTe cell with a condenser area of 35 cm². A spectral filter of dimensions 7.5×5.5 cm² was adhered to the photovoltaic surface using tape. The thermal absorber module incorporated a 5×5 cm² black-coated absorber and a 25 cm² aluminum-film condenser. Capillary wicks were bonded to condensers using thermally conductive adhesive.

### Characterization

The optical properties of the filter were measured by a UV-VIS-NIR spectrometer (PE Lambda 1050+). The surface morphology of the capillary wick was characterized by Scanning Electron Microscope (Zesis EVO MA10). The contact angles were measured by a surface contact angle meter (DataPhysics OCA20) within an ambient temperature of 25 °C using 5 μL deionized water as the indicator.

### In-Lab Experiments

Simulated sunlight was provided by a SciSun-300 Solar Simulator (Class AAA, AM 1.5 filter). An electronic balance (ME503T, Mettler Toledo) was adopted to measure the mass change of the reservoir. The untreated water source is the collected seawater. The temperature was measured by K-type thermocouples through a Keysight DAQ970A data acquisition system. The room temperature was maintained at 21±0.5 °C. To expedite the cooling of the PV module, it is left uninsulated during operation. In contrast, to maximize heat recovery and minimize side heat loss, the TA module is wrapped with insulating material that has a thermal conductivity of 0.023 W/m·K. The absorber is coated with commercial resin black paint. To minimize front heat transfer, a transparent aerogel, 1 cm thick with a thermal conductivity of 0.023 W/m·K, is used as an insulating layer. Infrared images were taken by a thermal imaging camera (Fluke, Tis60). The J-V and P-V curves of the solar cell were measured by a source meter (Keithley 2460).

### Outdoor Experiments

The outdoor experiment was conducted from 9:30 to 17:00 on the balcony of City University of Hong Kong, located in Kowloon Tong, Hong Kong, on Oct. 17-19, 2024. The 5,4S-SSCD device used for outdoor experiments is identical to the one used in the laboratory. The standalone PV and 5,4S-SSCD used for benchmarking and comparison were both tilted at 45° facing south. The brine source (3.5% wt) for the outdoor test was prepared by sodium chloride and kept in a reservoir wrapped with aluminum foil. A radiometer (HSTL-ZFSQ, HKXY) and a cup anemometer (HuaKong, FS01) were applied to measure the in-situ radiation and velocity. The temperatures were also measured by K-type thermal couples. A data acquisition module (ART DAM3071) loaded the readings of meteorological sensors and thermocouples to a laptop. Both the standalone PV and 5,4S-SSCD were connected in series with a resistor of 25 and 30 ohms, respectively. Current data measured by a coulomb meter and a multimeter were transmitted to a laptop, as well as an electrical balance (YP20001B, LICHEN) for mass change data.

The invention has been given by way of example only, and various other modifications of and/or alterations to the described embodiment may be made by persons skilled in the art without departing from the scope of the invention as specified in the appended claims.

1. A system for photovoltaic cooling and desalination, comprising:
a filter configured to separate an incident solar energy into a first energy beam and a second energy beam;
a photovoltaic module, comprising a photovoltaic cell configured to receive and convert a portion of the first energy beam into electricity, the photovoltaic cell having a surface in thermal contact with untreated water such that heat generated at the photovoltaic cell during conversion evaporates the untreated water into vapor;
a thermal absorbing module, comprising a thermal absorbing membrane configured to receive and convert a portion of the second energy beam into heat, the thermal absorption membrane having a surface in thermal contact with untreated water such that heat generated at the thermal absorption membrane evaporates the untreated water into vapor;
wherein each of the photovoltaic module and the thermal absorbing module further comprises a condenser component, the condenser component adapted to condense the vapour to freshwater.

2. The system as claimed in claim 1, wherein the condenser component comprises a plurality of condenser layers spaced apart from each other to enable the vapour to pass between and condense thereon.

3. The system as claimed in claim 2, wherein the condenser component comprises a frame structure configured to secure each of the plurality of condenser layers in place.

4. The system as claimed in claim 2, wherein each of the photovoltaic module and the thermal absorption module further comprises a fluid delivery unit configured to draw untreated water to evaporation sites associated with the condenser layers.

5. The system as claimed in claim 4, wherein the fluid delivery unit comprises a first plurality of capillary wicks, each attached to a back surface of a condenser layer, opposite to a condensing surface of a subsequent condenser layer.

6. The system as claimed in claim 4, wherein the fluid delivery unit further comprises two capillary wicks each attached to the surface of the photovoltaic cell and the thermal absorbing membrane.

7. The system as claimed in claim 5, wherein each capillary wick is spaced from the subsequent condenser layer by 2 mm to 8 mm.

8. The system as claimed in claim 5, wherein the plurality of capillary wicks have a collective end immersed in an untreated water source, configured to draw the untreated water to the photovoltaic cell, the thermal absorbing membrane, and the plurality of condenser layers.

9. The system as claimed in claim 4, wherein the fluid delivery unit is further configured to collect and direct the freshwater out of the condenser component.

10. The system according to claim 9, wherein the fluid delivery unit comprises a second plurality of capillary wicks each in contact with a condensing surface of a condenser layer configured to collect and direct the freshwater.

11. The system as claimed in claim 10, wherein the second plurality of capillary wicks have a collective end leading to a container for collecting the freshwater.

12. The system as claimed in claim 1, wherein the thermal absorbing membrane is an aluminium plate coated with a heat absorbing material selected from any one of black ink paint, resin paint, nanocarbon tube, or a combination thereof.

13. The system as claimed in claim 12, the thermal absorbing membrane is further covered with a transparent and low thermal conductivity material selected from any one of aerogel, glass, polymer or a combination thereof.

14. The system as claimed in claim 2, wherein each of the plurality of condenser layers is a metal plate.

15. The system as claimed in claim 1, wherein the filter is a spectral splitting filter configured to transmit photons in a wavelength ranging from 385 nm to 863 nm to the photovoltaic module, and reflect photons in a wavelength ranging from 863 nm to 2500 nm to the thermal absorber module.

16. A method for photovoltaic cooling and desalination, comprising steps of:
separating, by a filter, incident solar energy into a first energy beam and a second energy beam;
directing the first energy beam to a photovoltaic module comprising a photovoltaic cell configured to receive and convert a portion of the first energy beam into electricity, and directing the second energy beam to a thermal absorbing module comprising a thermal absorbing membrane configured to receive and convert a portion of the second energy beam into heat;
transporting untreated water into thermal contact with the photovoltaic cell and the thermal absorbing membrane such that heat generated thereby evaporates the untreated water into vapor;
condensing, by a condenser component in each of the photovoltaic module and the thermal absorbing module, the vapor into freshwater.

17. The method as claimed in claim 16, wherein the condenser component comprises a plurality of condenser layers spaced apart from each other to enable the vapour to pass between and condense thereon.

18. The method as claimed in claim 17, wherein the transporting of untreated water to the photovoltaic module and the thermal absorption module is performed by a fluid delivery unit configured to draw the untreated water to evaporation sites associated with condenser layers in each module.

19. The method as claimed in claim 18, wherein the fluid delivery unit comprises a first plurality of capillary wicks, each attached to a back surface of a condenser layer, opposite to a condensing surface of a subsequent condenser layer.

20. The method as claimed in claim 19, further comprising a step of collecting and directing the freshwater out of the condenser component by a second plurality of capillary wicks.
